(19) United States
(12) Patent Application Publication
(10) Pub. No.: US 2005/0223008 A1
(43) Pub. Date: Oct. 6, 2005

(54) Access right management system and method

(76) Inventors: Makoto Kubota, Kawasaki (JP); Yuji Kojima, Kawasaki (JP)

Correspondence Address: KATTEN MUCHIN ROSENMAN LLP, 575 MADISON AVENUE, NEW YORK, NY, 10022-2585, US

(21) Appl. No.: 10/949,673

(22) Filed: Sep. 24, 2004

(30) Foreign Application Priority Data
Mar. 31, 2004 (JP) 2004-104521

(51) Int. Cl. G06F 17/30

(52) U.S. Cl. 707/9

(57) ABSTRACT

In an access right management system and method which manage access to data and prevent the data from leaking, a plurality of associated users who possess access rights to data are registered in a user account database, users who agree to the access to the data at present among the access right possessing users are registered in an active user database, and an access agreement portion agrees, only when a present number of access right possessing users having agreed and registered in the active user database is plural, to the access to the data with access right possessing users who have requested the access to the data.

### BACKGROUND OF THE INVENTION

1. Field of the Invention

The present invention relates to an access right management system and method, and in particular to an access right management system and method which manage access to data and prevent the data from leaking.

Together with a recent highly advanced communication technology, an enormous amount of classified information such as industrial secret information (design document, etc.) and privacy information (directory, etc.) is transferred over a network, so that a leakage of the information grows into a problem. Not only a flow of information by unauthorized users originally having no access right but also an intentional or accidental flow of information by authorized users having an access right acquires a large part of factors of the classified information leakage, which makes an access right management technology more and more important.

2. Description of the Related Art

Specific examples of classified information leakage include takeout of a storage medium such as a CD/FD, takeout of information in the form of an electronic file by an electronic mail, browsing of data by a mobile terminal (notebook PC/PDA, etc.) in the public such as a train, and the like. According to these examples, it can be said that the classified information being freely accessible depending on an intention of a user having an access right is a main factor of the information leakage.

In order to solve such a leakage problem, various kinds of authentication systems and a system which provides accessibility only in a communication environment where files are encoded or encrypted and an encoding key can be exchanged with a document management server have been developed and introduced.

FIG. 24 shows an example of a prior art classified information leakage preventing system (access right management system), which is composed of a management server 70 and clients 10a_1-10a_3 (hereinafter, represented by a reference numeral 10a) connected with a network 60. The management server 70 is provided with a document management DB (database) 81, a key management DB 82, a user management DB 83, a user operation management DB 84, and management softwares managing the databases. Each client 10a is provided with user exclusive operation control software.

Users 1-3 corresponding to the clients 10a respectively transmit an editing request 900 for e.g. a document J to the management server 70 through the exclusive operation control software, receives authentication from a management software of the management server 70, and then downloads an encoded document J and a key K together with an edition enable 901 from the management server 70. The client 10a decodes the encoded document J into a normal document J with the key K. It is to be noted that the users 1-3 (clients 10a) can perform operations to the document within a range of an access right set in the user management DB 83 and the user operation management DB 84. The document operations include, for example, browsing 84a, storing 84b, editing 84c, printing 84d, copying & pasting 84e, and screen capturing 84f.

Since the client 10a cannot perform the operations to the decoded document without going through the user operation control software exclusively for system, operations outside the range of the access right permitted can not be performed. The user 1, for example, has the access right only for browsing and editing operations for the document name J. It is to be noted that a range of document kinds (Word, Excel, Acrobat, etc.) which become objects of the operations depends on a mounting layer of the user control software. Generally, when the user control software is mounted on the layer close to a kernel layer of OS, a wider range of documents can become an object. Also, there is a mounting example of arranging a management server performing a user management, a user operation management, and a key management essential thereto, and a content server performing a document management as different servers (see e.g. non-patent document 1).

However, it is a problem that an unauthorized operation can be performed depending on an intention of a single user having an access right, and a possibility that data leakage to outside of a company is increased especially when access to data in an intranet from outside of the company is permitted by a technology such as VPN (Virtual Private Network) connection. On the other hand, when the access from the outside of the company is not permitted, a problem of impairing convenience arises in a recent mobile society.

As a prior art system for solving this problem, there is an example in which a position of a user can be managed by a system with GPS or the like and by using this position information, whether or not data should be read out is controlled. In these examples, the system enhances resistance for leakage by permitting browsing only when an access enabling position registered in the database coincides with an actual position.

Also, there is an access right management system in which the position information of the user and a terminal are managed, and an access request is permitted when the user having a predetermined access right to computer resources has requested an access, and only when the position information of the user and the position information of the terminal which has requested the access are in a predetermined relationship (e.g. see patent document 1).

However, in these systems, a problem that the unauthorized operation can be performed depending on an intention of a single user having an access right remains unchanged after all.

[Patent Document 1]

Japanese Patent Application Laid-open No. 2001-175601

[Non-Patent Document 1]

ReEncryption:http://www.reencryption.com/frame_j2.html

Furthermore, as a prior art system for solving the above-mentioned problem, there is an example in which a document is distributed to a plurality of servers to be stored by noticing brittleness of a centralized management of documents by a content server, thereby improving the security. However, since a single management person (user) performs a server management, an unauthorized operation can be performed depending on the management person's intention, which still leaves the problem.

### SUMMARY OF THE INVENTION

It is accordingly an object of the present invention to provide an access right management system and method which manage access to data and prevent data from leaking, whereby an intentional or accidental data leakage by users having an access right is prevented.

In order to achieve the above-mentioned object, an access right management system according to the present invention comprises: a user account database associating a plurality of users, with data, who possess access rights to the data; an active user database indicating users who agree to an access to the data at present among the access right possessing users; and an access agreement portion which agrees, only when a present number of the access right possessing users having agreed and indicated in the active user database is plural, to the access to the data with access right possessing users who have requested the access to the data.

FIG. 1 shows a principle of an access right management system 100 according to the present invention, which is provided with a user account database 41, an active user database 44, and an access agreement portion 31.

In the user account database 41, a plurality of access right possessing users who possess access rights to data (e.g. industrial classified information such as design document, privacy information such as directory, etc.) are associated with the data. The active user database 44 indicates access right possessing users who agree to an access to the data at present among the access right possessing users associated by the user account database 41. The agreement in this case is applied in the case where e.g. the access right possessing users are positioned in the same area.

The access agreement portion 31 agrees, only when a present number of the access right possessing users having agreed and indicated in the active user database 44 is plural, to the access to the data with access right possessing users who have requested the access to the data.

Thus, it becomes possible to prevent the intentional or accidental data leakage by a single user having an access right, and to provide a data access environment (system) in which resistance for the data leakage is enhanced compared with a prior art system.

Also, in the present invention according to the above-mentioned invention, the system may be composed of a server and one or more clients, the server may be provided with the user account database, the active user database, and the access agreement portion, each of the clients may be provided with a position information detector which detects a present position of its own, and an access request portion which transmits the detected present position and an access request received from the user to the access agreement portion, and the access agreement portion may register the received present position associated with the access right possessing users in the active user database, and a number of users positioned within a predetermined area may be made a present number of agreed users.

In FIG. 1, the access right management system 100 is composed of a plurality of clients 10_1 and 10_2 (hereinafter, occasionally represented by a reference numeral 10), and a server 30. Each client 10 is provided with a position information detector (not shown: e.g. a position information receiver which receives position information from a position information transmitting device) which detects its own present position, and an access request portion 11 which transmits the detected present position or an access request received from the user for data to the access agreement portion 31.

The server 30 is provided with the user account database 41, the active user database 44, and the access agreement portion 31. This access agreement portion 31 registers the present position received from each client 10 associated with the user in the active user database 44. Upon access request for the data from the client (access right possessing user) 10, the access agreement portion 31 makes a number of users positioned within a predetermined area the present number of the access right possessing users who have agreed as above noted, by referring to the active user database 44, and agrees (enables) the access only when this present number is plural.

Thus, it becomes possible for the access right possessing user to access the data by the agreement of the access right possessing users positioned within a predetermined area.

It is to be noted that the client and the user do not always correspond one-to-one with each other, and a plurality of users may use the same client.

Also, the setting of “required number of users” is added and the existence of the number of active users equal to or more than the required number of users may be regarded as the access agreement, instead of “access agreement only when the number of users is plural” in the above-mentioned description.

Also, in the present invention according to the above-mentioned invention, the system may be composed of a server and one or more clients, the server may be provided with the user account database, the active user database, and the access agreement portion, each of the clients may be provided with a network structuring portion which structures a network with other clients, and an access request portion which transmits identification information of the access right possessing users of the client which has structured the network and an access request received from the user of its own client to the access agreement portion, and the access agreement portion may register the access right possessing users of the identification information in the active user database as the access right possessing users who have agreed to the access to the data.

Namely, the access right management system 100 is composed of one or more clients 10 and the server 30. Each client 10 is provided with a network structuring portion (not shown) and the access request portion 11. The network structuring portion structures a network (e.g. ad hoc network; not shown) with other clients 10, and the access request portion 11 transmits identification information of the access right possessing users of the client 10 which has structured the network and an access request for the data received from the user of its own client to the access agreement portion 31.

The server 30 is provided with the user account database 41, the active user database 44, and the access agreement portion 31. This access agreement portion 31 registers the access right possessing users of the identification information received from each client 10 in the active user database 44 as the access right possessing users who have agreed to the access to the data.

The access agreement portion 31 agrees the access only when the present number of access right possessing users who have agreed is plural by referring to the active user database 44 upon access request for the data from the client 10.

Thus, it becomes possible for each access right possessing user to access data by the agreement of each access right possessing user positioned within a predetermined area indicated by e.g. the ad hoc network having been connected.

It is to be noted that a network where clients are connected with cables of adequate length may be substituted for the ad hoc network.

Also, in the present invention according to the above-mentioned invention, each of clients may be further provided with a network structuring portion and an access request portion besides the user account database, the active user database, and the access agreement portion, the network structuring portion may structure a network with other clients, the access agreement portion may register the access right possessing users of the client connected to the structured network in the active user database as the access right possessing users who have agreed to the access to the data, and the access request portion may provide an access request received from the user of its own client to the access agreement portion of the client holding the data.

Namely, the access right management system is composed of only a plurality of clients. Each of the clients is further provided with a network structuring portion and an access request portion besides the user account database, the active user database, and the access agreement portion.

The network structuring portion structures e.g. the ad hoc network with other clients. The access agreement portion registers the access right possessing users of the client connected to the structured network at present in the active user database as the access right possessing users who have agreed to the access to the data.

The access request portion performs an access request received from of its own client to the access agreement portion of the client holding the data, and the access agreement portion having received the access request agrees the access only when the present number of access right possessing users who have agreed is plural by referring to the active user database.

Thus, it becomes possible to determine the agreement of a plurality of users without requiring the server and to improve the resistance for the data leakage by distributing the access agreement portion to each client.

Also, in the present invention according to the above-mentioned invention, each of the clients may be further provided with a database structuring portion, and the database structuring portion may register a plurality of associated users who possess the access rights to the data in the user account database or may delete the users from the user account database.

Namely, each client is provided with a distributed database structuring portion. This database structuring portion can register a plurality of associated users who possess the access rights to the data in the user account database or can delete the users from the user account database.

Thus, it becomes possible to structure the system without the server 30, and to enhance protection ability (resistance) for a leakage of the system since the information leakage from a privileged server management person is prevented and a plurality of users mutually monitor.

Also, in the present invention according to the above-mentioned invention, the server may hold the data.

Also, in the present invention according to the above-mentioned invention, the client may be further provided with a data storing portion which holds the data distributed, and a data transmitter and receiver which transmit/receive the data with other clients.

Namely, the client is further provided with a data storing portion, a data transmitter, and a data receiver besides the above-mentioned portions. For example, a single document file (data) is distributed to be stored in the data storing portion of each own client. When the access to the document file to which a certain client has requested is agreed, the data transmitter of another client transmits the distributed document file stored in the data storing portion to the client which has requested the document file. The data receiver of the client receives the data transmitted from the other clients to form a single document file.

Thus, even if the security of an individual client is broken, the entire data do not leak, thereby enhancing the protection ability for the leakage. It is to be noted that the transmission/reception of the data may be performed through the network connecting the server and the clients, or the ad hoc network mutually connecting the clients.

Also, the present invention according to the above-mentioned invention may further comprise a database structuring portion which registers a plurality of associated users who possess the access rights to the data in the user account database or deletes the users from the user account database.

Furthermore, in order to achieve the above-mentioned object, an access right management method according to the present invention comprises: a first step of registering a plurality of associated users who possess access rights to data; a second step of registering users who agree to access to the data at present among the access right possessing users; and a third step of agreeing, only when a present number of access right possessing users having agreed is plural, to the access to the data with access right possessing users who have requested the access to the data.

As described above, the access right management system according to the present invention is arranged so that the agreement of a plurality of users is required for access enable/disable. Therefore, the resistance for the data leakage is improved compared with prior art systems which determine access enable/disable per user.

Also, the access right management system is arranged so that the agreement of a plurality of users is determined based on the position information of the users. Therefore, ease of the system operation and procedure upon data access of each user is the same as that of the prior art system, and the resistance for the data leakage is improved without troubles of users upon using the system.

Also, the access right management system is arranged so that a plurality of users are positioned close within the same area to compose a network and the access agreement is determined by a plurality of users. Therefore, the resistance for the data leakage is improved even if an absolute position of each user can not be obtained.

Also, the access right management system is arranged so that data are distributed to each client to be held. Therefore, a used bandwidth of the network between the server and the client is saved and the resistance for the data leakage is improved. Furthermore, by holding the distributed data, even if the security of individual client is broken, the entire data do not leak. Therefore, the protection ability for the leakage is enhanced since the entire data do not leak.

Also, the clients hold the distributed access agreement portion, whereby the agreement of a plurality of users is determined without requiring the server and the resistance for the data leakage is improved.

Furthermore, the clients hold the distributed database structuring portion, whereby the system can be structured without the server, and there is an effect of enhancing the protection ability for the leakage of the system since the information leakage from the privileged server management person can be prevented and a plurality of members perform a cross-check.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing a principle of an access right management system and method according to the present invention;

FIG. 2 is a block diagram showing a system arrangement in an embodiment (1) of an access right management system according to the present invention;

FIGS. 3A and 3B are diagrams showing a user account database in an embodiment (1) of an access right management system according to the present invention;

FIGS. 4A and 4B are diagrams showing an active user database in an embodiment (1) of an access right management system according to the present invention;

FIG. 5 is a flowchart showing an operation procedure in an embodiment (1) of an access right management system according to the present invention;

FIG. 6 is a block diagram showing a system arrangement in an embodiment (2) of an access right management system according to the present invention;

FIG. 7 is a block diagram showing a table example held by a general ad hoc network structuring portion;

FIGS. 8A and 8B are diagrams showing a user account database in an embodiment (2) of an access right management system according to the present invention;

FIG. 9 is a diagram showing an active user database in an embodiment (2) of an access right management system according to the present invention;

FIG. 10 is a flowchart showing an operation procedure in an embodiment (2) of an access right management system according to the present invention;

FIG. 11 is a block diagram showing a system arrangement in an embodiment (3) of an access right management system according to the present invention;

FIGS. 12A and 12B are diagrams showing a user account database in an embodiment (3) of an access right management system according to the present invention;

FIG. 13 is a diagram showing an active user database in an embodiment (3) of an access right management system according to the present invention;

FIGS. 14A and 14B are diagrams showing a document file database in an embodiment (3) of an access right management system according to the present invention;

FIG. 15 is a flowchart showing an operation procedure in an embodiment (3) of an access right management system according to the present invention;

FIG. 16 is a block diagram showing a system arrangement in an embodiment (4) of an access right management system according to the present invention;

FIGS. 17A-17C are diagrams showing a user account database for “agreement of access right to document” in an embodiment (4) of an access right management system according to the present invention;

FIGS. 18A and 18B are diagrams showing an active user database for “agreement of access right to document” in an embodiment (4) of an access right management system according to the present invention;

FIGS. 19A and 19B are diagrams showing a document file database for “agreement of access right to document” in an embodiment (4) of an access right management system according to the present invention;

FIG. 20 is a flowchart showing an operation procedure for “agreement of access right to document” in an embodiment (4) of an access right management system according to the present invention;

FIGS. 21A-21D are diagrams showing a user account database for “access right management upon distributing database structuring portion” in an embodiment (4) of an access right management system according to the present invention;

FIGS. 22A-22C are diagrams showing a document file database for “access right management upon distributing database structuring portion” in an embodiment (4) of an access right management system according to the present invention;

FIG. 23 is a sequence diagram showing an operation procedure for “access right management upon distributing database structuring portion” in an embodiment (4) of an access right management system according to the present invention; and

FIG. 24 is a block diagram showing a prior art access right management system.

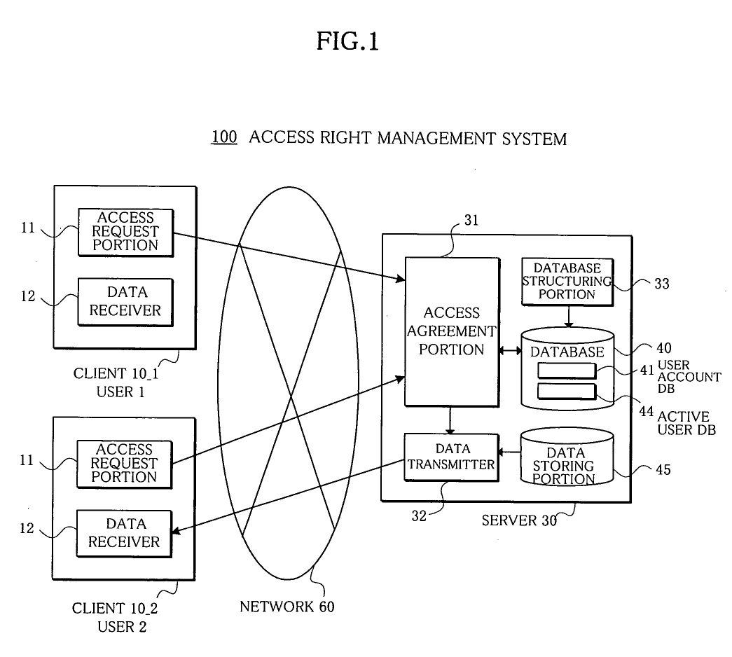

### DESCRIPTION OF THE EMBODIMENTS

### Embodiment (1): Access Agreement Based on Position Information

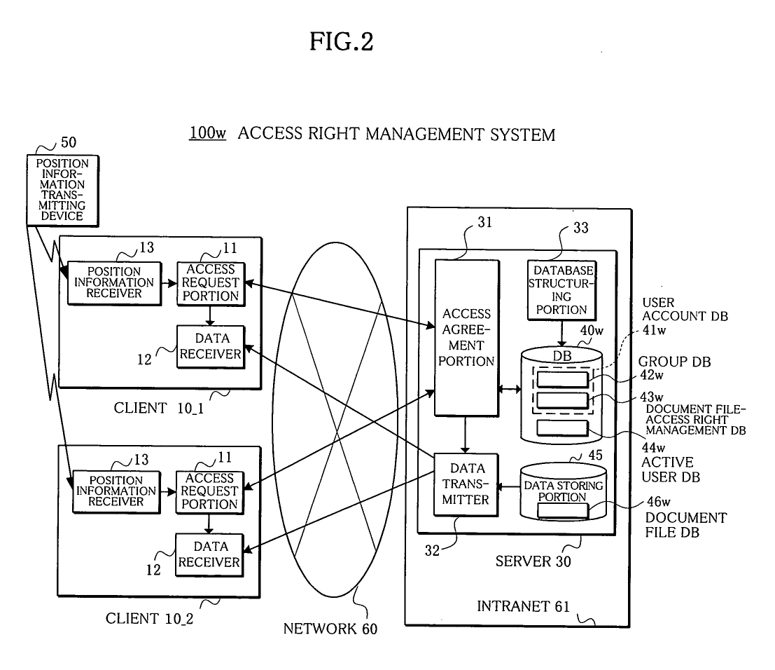

FIG. 2 shows an arrangement of an access right management system 100w in an embodiment (1) of the present invention. This access right management system 100w is composed of the server 30, and the clients 10_1 and 10_2 (hereinafter, occasionally represented by a reference numeral 10), which are connected with the network 60. In FIG. 2, a position information transmitting device 50 is also shown besides the access right management system 100w. The server 30 is provided with the access agreement portion 31, the data transmitter 32, the database structuring portion 33, a database 40w, and a data storing portion 45. Each client 10 is provided with the access request portion 11, the data receiver 12, and a position information receiver 13.

The position information receiver 13 detects the present position of the client 10 by communicating with the position information transmitting device 50. As the position information transmitting device 50, e.g. a GPS (Global Positioning System) can be mentioned, which is a system of measuring a position relationship between the client 10 and a satellite by using some information transmitted from the satellite and of calculating a latitude and a longitude of the present position of the client 10. Each client 10 can detect its own present position by using the position information receiver 13. It is to be noted that while the GPS is used as present position detecting means in the embodiment (1), the present position detecting means is not limited to the GPS.

The database 40w of the server 30 is composed of a user account database 41w and an active user database 44w. The database 41w is composed of a group database 42w and a document file-access right management database 43w.

The embodiment (1) shows, for example, a case where the server 30 is connected to the network 60 through an intranet 61 (see FIG. 2) of a company A, and users (employees) 1 and 2 (not shown) respectively access a company confidential document file stored in the data storing portion 45w of the server 30 by using the clients 10_1 and 10_2, from a place visited on business (business trip destination). For such a system operation, the database structuring portion 33 of the server 30 preliminarily prepares the group database 42w and the document file-access right management database 43w in the user account database 41w storing accounts of the users 1 and 2.

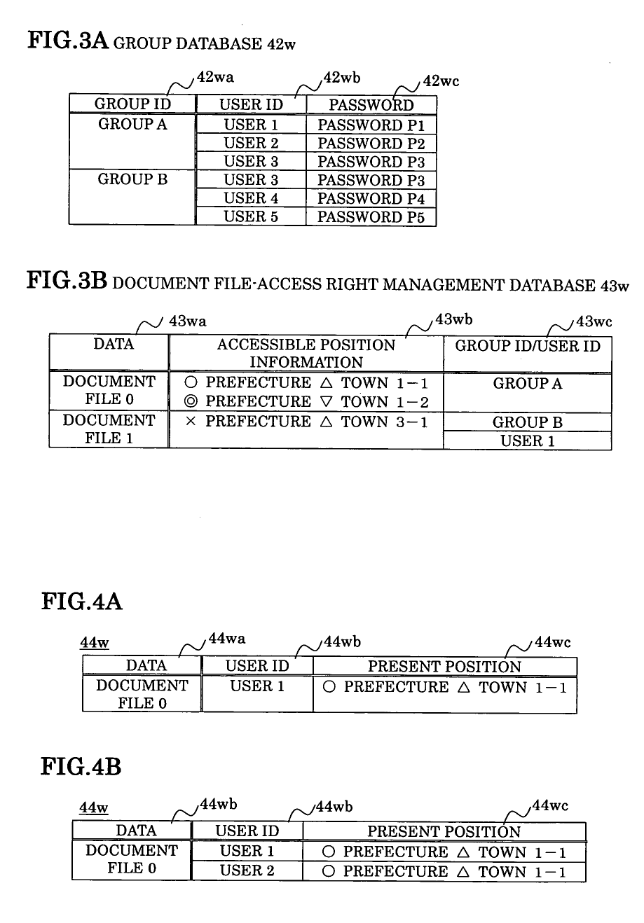

FIGS. 3A and 3B respectively show the group database 42w and the document file-access right management database 43w composing the user account database 41w (see FIG. 2). The group database 42w shown in FIG. 3A is composed of a group identifier (hereinafter, occasionally abbreviated as ID) 42wa, a user identifier 42wb, and a password 42wc. In the database 42w, for example, the users “1-3” of the user ID 42wb are registered as belonging to the group ID 42wa=“group A”, and respectively having the password 42wc=“P1-P3”.

The document file-access right management database 43w shown in FIG. 3B is composed of data 43wa, accessible position information 43wb, and a group ID/user ID 43wc. In the database 43, it is registered, for example, that only users (users 1-3 (see FIG. 3A)) which belong to the group ID/user ID=“group A” positioned in the accessible position information 43wb=“◯ prefecture Δ town 1-1” or “◯ prefecture Δ town 1-2” can access the data 43wa=“document file 0”.

Besides the association of the user group (group ID) with the document file, the association per user ID only or the association per combination of the group ID and the user ID is possible.

A data registration/deletion in/from the databases 42w and 43w can be performed through the database structuring portion 33. The registration may be e.g. a manual registration by a management person of the server 30 or an automatic registration with an account preparation request from each user (employee) being made a trigger.

It is to be noted that while only browsing is described in the embodiment (1) and embodiments (2)-(4) described later as an access to the document file, access for such as storing of document, editing, printing, copying & pasting, and screen capturing is possible.

FIGS. 4A and 4B show an arrangement of the active user database 44w shown in FIG. 2. This database 44w is composed of data 44wa, a user ID 44wb, and the present position 44wc of a user. FIG. 4A shows the database 44w in the case where only the user 1 starts up the clients 10_1. FIG. 4B shows the database 44w in the case where the users 1 and 2 respectively start up the clients 10_1 and 10_2.

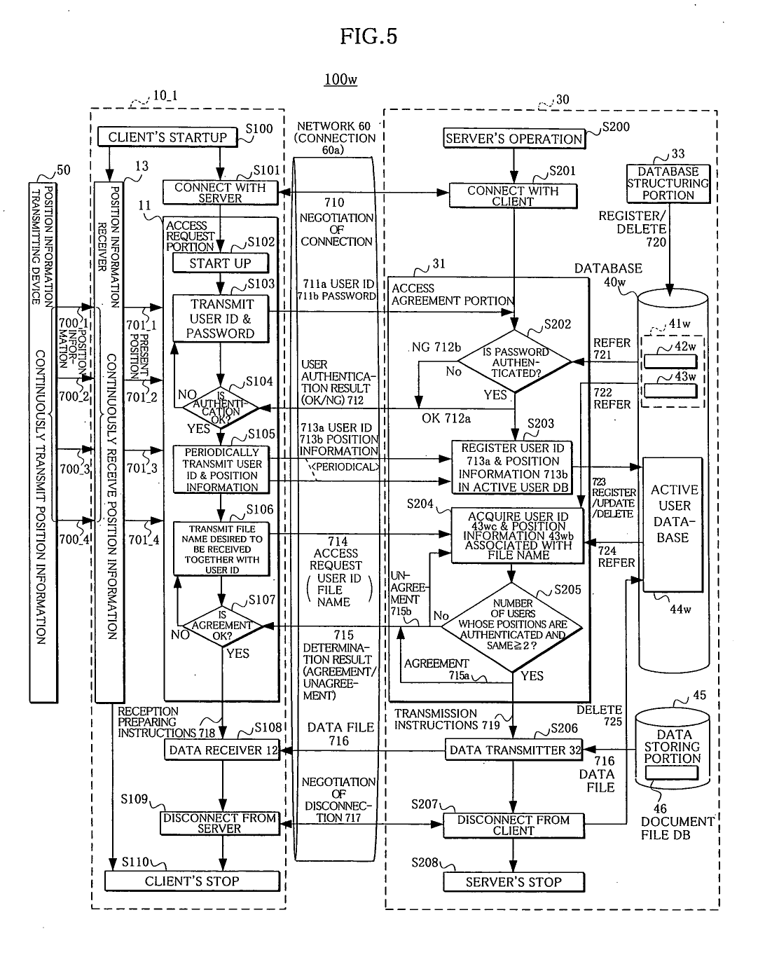

FIG. 5 shows an operation example of the access right management system 100w of the embodiment (1) shown in FIG. 2. This operation example will now be described.

The users (employees) 1 and 2 (not shown) respectively preset the address of the server 30 in the clients 10_1 and 10_2 where client 10_2 is shown in FIG. 2.

Steps S200 and S100: The server 30 already is in operation, and the user 1 starts up the client 10_1 at e.g. a place visited on business. On this occasion, it is supposed that the client 10_2 of the user 2 is not started up yet. The position information receiver 13 of the client 10_1 receives position information 700_1, 700_2, . . . from the position information transmitting device, and notifies present positions 701_1, 701_2, . . . of the client 10_1 as detected to the access request portion 11.

Steps S101 and S201: Negotiations of connection 710 are performed between the client 10_1 and the server 30, and a connection 60a is set up through the network 60 between the client 10_1 and the server 30.

Steps S102 and S103: In the client 10_1, the user 1 inputs a startup command to start up the access request portion 11. This access request portion 11 has e.g. a single application which operates on OS, and has an input screen interface for the user 1 to input the user ID and the password. The access request portion 11 transmits a user ID 711a and a password 711b inputted by the user 1 to the server 30.

Step S202: In the server 30, the access agreement portion 31 determines whether or not the password 711b is authenticated by referring (721) to the database 42w. A user authentication result 712 indicating an “authentication OK 712a” when authenticated, and an “authentication NG 712b” when unauthenticated is transmitted to the client 10_1.

Steps S104 and S103: In the client 10_1, when the user authentication result 712 indicates “authentication NG”, the access request portion 11 returns to the input screen of the user ID and the password at step S103.

Steps S104 and S105: When the user authentication result 712 indicates “authentication OK”, the access request portion 11 constantly or periodically (e.g. every 10 sec. or every several-meter movement of the present position) sets the server 30 to transmit a user ID 713a and position information (present position) 713b received by the position information receiver 13 to the access agreement portion 31, and then the process proceeds to step S106.

Step S203: In the server 30, the access agreement portion 31 registers (723) the user ID 713a and the position information 713b received, in the active user database 44w.

Namely, the access agreement portion 31 retrieves the user account database 41w by the user ID 713a and the position information 713b received, and determines whether or not an accessible position within the database coincides with the present position for each document file with which the user 1 is associated by this retrieval. When they are coincident with each other, the access agreement portion 31 recognizes that the user 1 is for e.g. a document file 0, and registers the user 1 in the active user database 44w. If the user ID has already been registered at this time, the present position 44wc is overwritten.

When they are not coincident with each other, access agreement portion 31 recognizes that the user is non-active for the document file 0, and deletes data associated with the user ID when the user 1 has been already registered in e.g. the active user database 44w.

In this example, the present position=“◯ prefecture Δ town 1-1” of the user 1 coincides with the position information 43wb of the document file-access right management database 43w for the document file 0, but it does not coincide with the position information 43wb for the document file 1. As a result, the active user database 44w becomes a database shown in FIG. 4A. Thus, by constantly or periodically updating the active user database 44w, the server 30 can grasp the present position of the client 10_1.

Step S106: The access request portion 11 transmits an access request 714 including a file name desired to be received (browsed) and the user ID to the server 30. Namely, the access request portion 11 transmits the access request 714 including the file name, desired to be accessed, =“document file 0” and the user ID=“user 1” with an “OK notification” of the above-mentioned user authentication result 712 and a desire to browse the document file 0 by the user 1, being made a trigger. It is to be noted that a specific method of triggering the desire to browse and of specifying the file name is not limited. However, an exclusive data folder may be prepared on the client 10_1 so that when the file name on the folder is clicked the access request portion 11 notifies the file name=“document file 0” and “user 1” to the server 30.

Steps S204 and S205: In the server 30, the access agreement portion 31 acquires the user ID 44wb and the present position 44wc associated (i.e. active) with the concerned file name=“document file 0” by referring to the active user database 44w, and checks whether or not two or more users (including user 1) whose present positions are the same as that of the user are registered in the database 44w.

When they are not registered, the access agreement portion 31 transmits to the client 10_1 a determination result (message) 715 indicating a “unagreement (meaning “not-yet-made agreement”) 715b” to the access request, transmits no data file, and returns to a reception waiting state of the present position from the client at step S203. When they have been already registered, the access agreement portion 31 returns the determination result 715 indicating an “agreement 715a” to the client 10_1, and further provides transmission instructions 719 of the “document file 0” to the data transmitter 32.

Since only the user 1 is registered in the database 44w at present as shown in FIG. 4A, the access agreement portion 31 returns to the client 10_1 the determination result 715 indicating the “unagreement 715b” to the access request 714, and provides no transmission instructions 719 to the data transmitter 32.

Step S107: In the client 10_1, the access request portion 11 receives the determination result 715 indicating “unagreement”, returns to step S106, and assumes an input waiting state of the file name and the user ID.

Hereafter, it is supposed that the user (employee) 2 starts up the client 10_2 (both are not shown) at the same place visited on business. The same operations as steps S101-S106 of the client 10_1 and steps S201-S203 of the server 30 mentioned above are performed between the client 10_2 and the server 30, and the user 2 is registered in the active user database 44w. FIG. 4B shows the active user database 44w in which the user 2 is further registered.

The operations between the client 10_2 and the server 30 hereafter will be described by referring to steps S106-S110 shown in the client 10_1 and steps S204-S208 in the server 30.

Step S106: In the client 10_2 (see client 10_1 in FIG. 5), the access request portion 11 transmits the access request 714 including the file name, desired to be received (browsed), =“document file 0” and the user ID=“user 2” to the server 30.

Steps S204 and S205: In the server 30, the access agreement portion 31 acquires the user ID 44wb and the present position 44wc associated (i.e. active) with the file name=“document file 0” by referring to the active user database 44w, and determines whether or not two or more users (including user 2) whose present positions are the same as that of the user are registered in the database 44w.

Since two users 1 (including user 2) who have access rights to the “document file 0” and whose present positions are the same as that of the user 2 are registered in the database 44w at present, as shown in FIG. 4B, different from the case of the client 10_1 shown in FIG. 4A, the access agreement portion 31 responds the determination result 715 indicating the “agreement 715a” to the access request 714 from the client 10_2. Furthermore, the access agreement portion 31 provides to the data transmitter 32 the transmission instructions 719 of the “document file 0” to the client 10_2.

Step S107: In the client 10_2, the access request portion 11 having received the determination result 715 indicating “agreement” provides file reception preparing instructions 718 to the data receiver 12.

Steps S206 and S108: In the server 30, the data transmitter 32 transmits a data file (=“document file 0”) 716 stored in a document file database 46w of the data storing portion 45 to the data receiver 12 of the client 10_2. The data receiver 12 receives the data file 716, and the user 2 of the client 10_2 can browse the “document file 0”.

It is to be noted that when the client 10_1 performs the access request 714 to the document file 0 to the server 30, the client 10_1 can access the document file 0 in the same way as the client 10_2.

Steps S109, S110, S207, and S208: After browsing the “document file 0”, the clients 10_1 and 10_2 exchange a negotiation 717 of a disconnection from the connection 60a with the server 30 to disconnect the connection 60a, so that the clients 10 and the server 30 stop their operations.

As described above, in the embodiment (1), when the user having the access right to the document file 0 desires the access to the document file 0, the existence of another user who has the access right to the same document file 0 at the adjoining position of the user is regarded as an access agreement, thereby permitting the access.

Thus, when a plurality of employees (users) make a business trip, documents can be browsed by the same procedure as the existing authentication system or the like. On the other hand, when a certain user tries to take out data without proper authorization, documents can not be browsed, thereby enhancing a protection ability for a data leakage.

It is to be noted that if “required number of users” is newly set, e.g. the “required number of users” is 5, and five or more active users exist, the existence may be regarded as the access agreement.

Also, in this embodiment (1), the position information is acquired with an absolute position (e.g. postal address) by the GPS. While this GPS is appropriate for an outdoor use, it is not so appropriate for an indoor use. Accordingly, this embodiment (1) is appropriate for the use at the time when e.g. a plurality of employees are on the move by transportation or at front steps of customers' houses upon visiting the customers.

The following modification may be applied as a variation of the embodiment (1).

In case of a data type associating an address and various information with each customer/inhabitant such as a customer/inhabitant registry, a client (terminal) is preliminarily lent to each customer, and an employee and customer input a user ID and a password to each client at a customer's home where the employee visits, which may be regarded as an agreement of a plurality of people based on the position information.

Also, it is possible to take a form that the client (terminal) itself is a single unit and each user inputs the user ID and the password to the client respectively.

Also, instead of the acquisition of the position information by the GPS, it may be done per access point of a mobile telephone or a wireless LAN which has begun to be popular. As for the acquisition of the position information by the mobile telephone, the unit of the position information is more rough than that of the GPS and the security is low, but it can be used indoors such as inside of buildings besides outdoors and is a flexibly applied form.

Also, a single client may correspond to only one of the above-mentioned acquisitions as an acquisition portion of the position information, or may be preliminarily provided with all of the acquisition portions to be used appropriately according to a usage environment (outdoors/indoors, circuit speed). Furthermore, it is preferable in terms of security that the connection between the client and the server is encoded by a technology such as IPsec (Security Architecture for the Internet Protocol), which is not indispensable through.

Also, in the above-mentioned each database and database structuring portion 33, it is possible that e.g. the access type (browsing, editing, printing, or the like) is designated per document file, and the access type is controlled per document/user.

Also, it is preferable for improving security that the access request portion 11 in the client 10 having received an NG notification from the server 30 has a mechanism that the subsequent connection is enabled after a fixed time, or the connection is disabled for some time after having received the NG notifications fixed times.

Furthermore, the access agreement portion 31 may take a form of acquiring the present position of another user with the reception of the access request of the user 2 from the client being made a trigger and of updating the position information of the active user database to the latest information, instead of a form that the present position is periodically notified from the client 10 after the OK notification is transmitted to the client 10_1 as mentioned above. Also, the access agreement portion 31 feels out the access enable/disable of the user 2 from the other user and may regard the other user's permission as the agreement, instead of determining agreement/unagreement automatically based on the number of users on the active user database.

### Embodiment (2): Access Agreement Based on Ad Hoc Network Connection

In the above-mentioned (1), agreement enable/disable is determined based on the absolute position of each user. In the embodiment (2), an agreement or unagreement to the access to the data is determined according to whether or not users positioned within an adjoining area mutually have structured a network (e.g. ad hoc network).

Accordingly, even in the status where each user's absolute position can not be acquired for such reasons that (1) radio wave from the GPS/mobile telephone/wireless LAN can not be received, (2) the absolute position can not be estimated based on the connection state of the mobile telephone/wireless LAN, or (3) even if it can be estimated, a sufficient grading can not be obtained, the embodiment (2) has an effect of obtaining the agreement of each user.

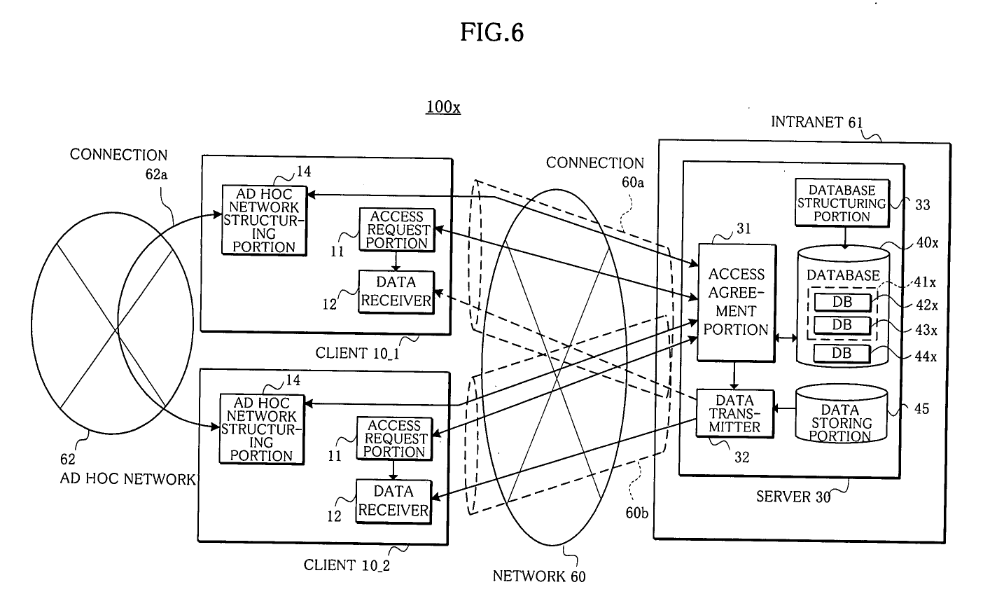

FIG. 6 shows an arrangement of an access right management system 100x in the embodiment (2) of the present invention. This access right management system 100x is composed of a plurality of clients 10 and the server 30 connected with the network 60 in the same way as the access right management system 100w shown in the embodiment (1). However, different from the embodiment (1), the position information transmitting device 50 is not required and the clients 10 are mutually connected with an ad hoc network 62.

The arrangement of the server 30 is basically the same as that of the server 30 of the embodiment (1), while a database 40x is different. The client 10 is provided with an ad hoc network structuring portion 14 instead of the position information receiver 13 of the client 10 in the embodiment (1).

As a general prior art technology of structuring a network by adjoining users (clients) positioned within the same area, an ad hoc network can be mentioned. The ad hoc network is a network taking a form of mutually connecting numerous terminals not through access points with technologies such as IEEE802.11x and Bluetooth widely used for a wireless connection of computers and the like. In the ad hoc network, a network can be composed only of mutual terminals in the place where an infrastructure such as a base station and an access point does not exist. Contrarily, unless the terminals are adjoining or adjacent to each other within a distance depending on a wireless technology used, the mutual terminals can not structure the network. It is to be noted that as means for structuring the network by users adjoining within the same area, the terminals may be mutually connected with wire of an adequate length at an appropriate time, while being less convenient compared with the ad hoc network.

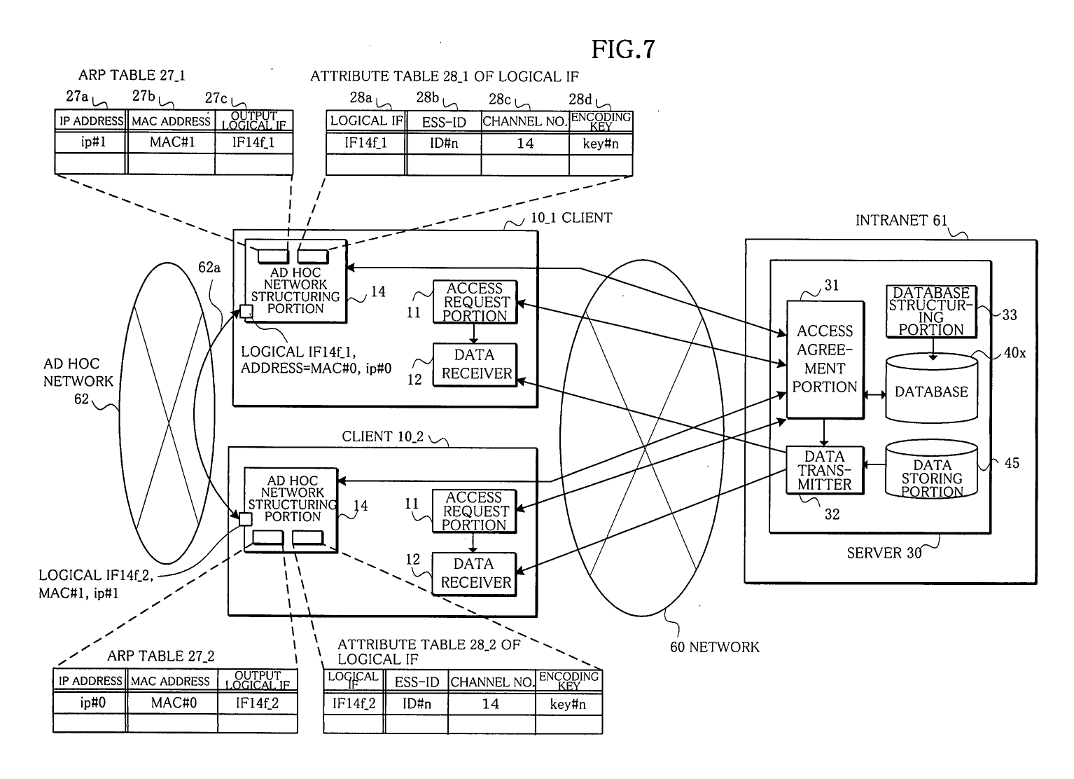

FIG. 7 shows in more detail the arrangement of the general ad hoc network structuring portions 14 in the clients 10_1 and 10_2 shown in FIG. 6. The ad hoc network structuring portions 14 are respectively provided with ARP (Address Resolution Protocol) tables 27_1 and 27_2 (hereinafter, occasionally represented by a reference numeral 27), attribute tables 28_1 and 28_2 (hereinafter, occasionally represented by a reference numeral 28) of a logical interface (hereinafter, occasionally abbreviated as a logical IF), and logical interfaces 14f_1 and 14f_2 (hereinafter, occasionally represented by a reference numeral 14f).

It is to be noted that the technology of the ad hoc network structuring portion 14 may use a prior art ad hoc network technology, and the tables 27 and 28 show examples in a wireless LAN technology of IEEE802.11x. Namely, the ARP table 27 is composed of an IP address 27a, a MAC address 27b, and an output logical IF 27c as client information within the ad hoc network 62. The attribute table 28 of the logical IF is composed of an ESS-ID (Extended Service Set Identifier) 28b, a channel No. (frequency) 28c, and an encoding key 28d which are supplementary information of the logical interface 14f, as information per ad hoc network group. It is to be noted that the ESS-ID is an identifier in the wireless LAN prescribed by the IEEE802.11x series, which is used as the identifier of the ad hoc network in this embodiment (2).

When transmitting data to the client 10_2 over the ad hoc network 62, e.g. the client 10_1 acquires a parameter such as MAC address=“MAC#1” corresponding to a destination IP address=“ip#1” by referring to the tables 27_1 and 28_1, and encodes the data with the wireless LAN technology of the IEEE802.11 to be transmitted to the client 10_2. The client 10_2 decodes the received data based on the tables 27_2 and 28_2. Thus, the data communication is performed within the ad hoc network 62.

In the embodiment (2), a plurality of clients 10 exist within the area which can be connected by the ad hoc network 62. Only when they are connected, the access agreement portion 31 of the server 30 agrees to the access to the data by the clients 10. The management of the connection state of the clients 10 is performed by the database 40x.

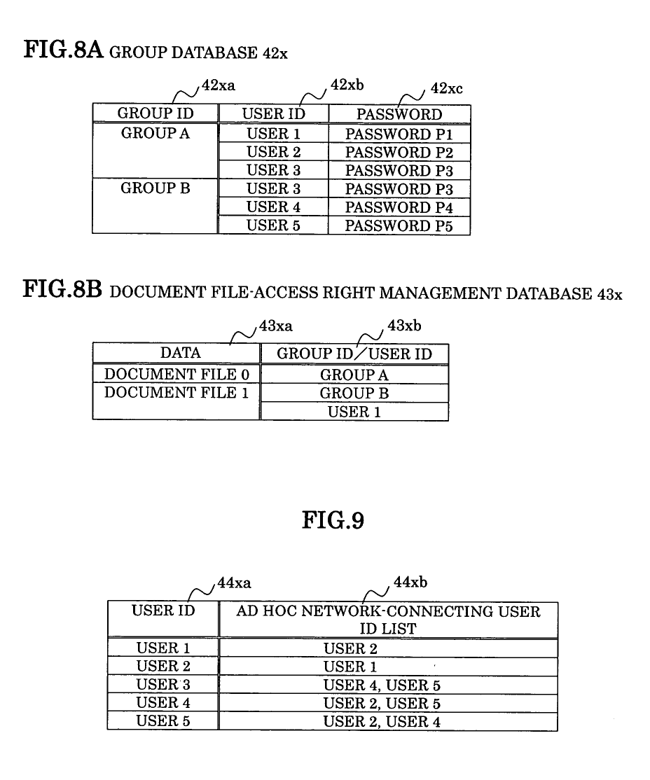

FIGS. 8A and 8B show a user account database 41x in the database 40x shown in FIG. 6. FIGS. 8A and 8B respectively show a group database 42x and a document file-access right management database 43x within the database 41x. The database 42x is the same as the database 42w of the embodiment (1) shown in FIG. 3A, while the database 43x is different from the database 43w shown in FIG. 3B in that there is not position information 43wb which enables access.

FIG. 9 shows an active user database 44x shown in FIG. 6. This database 44x is different from the active user database 44w of the embodiment (1) shown in FIGS. 4A and 4B, and is composed of a user ID 44xa and an ad hoc network-connecting user ID list 44xb. The ad hoc network-connecting user ID list is a list of an identifier of an opposite user with which a user having the user ID 44xa can communicate at present through the ad hoc network 62.

By the database 44x of FIG. 9, it is recognized that the opposite user “user 2” (a single user) of e.g. the “user 1”, and the opposite users “users 4 and 5” (two users (list of a plurality of names)) of the “user 3” mutually structure the ad hoc network.

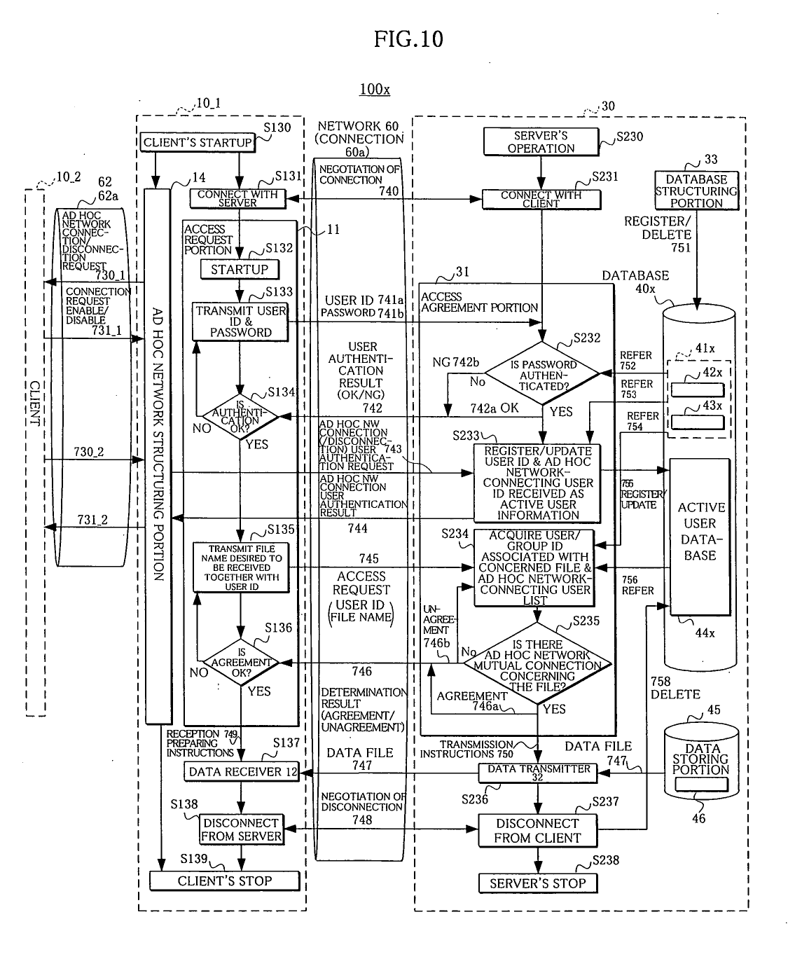

FIG. 10 shows an operation example of the access right management system 100x of the embodiment (2) shown in FIG. 6, which will now be described.

Steps S130 and S131: The server is operated, the client 10_1 is started up by the user 1 (not shown), and the ad hoc network structuring portion 14 transmits an ad hoc network connection request 730_1 to the other client 10_2. It is supposed that the mechanism for the ad hoc network to find out other clients depends on the prior art ad hoc network technology. The ad hoc network structuring portion 14 of the client 10_1 receives an ad hoc network connection request enable/disable 731_1 from the other client 10_2. When the ad hoc network connection request enable/disable 731_1=“enable”, the ad hoc network structuring portion 14 of the client 10_1 structures the ad hoc network 62 with the client 10_2. When the ad hoc network connection request enable/disable 731_1=“disable”, it does not structure the ad hoc network 62 with the client 10_2.

The ad hoc network structuring portion 14 continuously and periodically tries to structure the ad hoc network by an event that new other clients have been found out.

Steps S131-S134, S231, and S232: The negotiation 740 of the connection and the user authentication between the server 30 and the client 10_1 are the same as those at steps S101-S104, S201, and S202 of the embodiment (1).

Step S233: In the client 10_1, contrary to step S130, the ad hoc network structuring portion 14 receives from the other client 10_2 an ad hoc network connection request 730_2 including the user ID and the password of the other client 10_2. Then, the ad hoc network structuring portion 14 provides an ad hoc network-connecting user authentication request 743 including the received user ID and the password to the access agreement portion 31 of the server 30.

When the received ad hoc network-connecting user authentication request 743 is authenticated (authentication enable) by referring to the group database 42x (see FIGS. 8A and 8B), the access agreement portion 31 registers or updates the user ID=“user 2” in the ad hoc network-connecting user ID list 44xb of the user ID=“user 1” of the active user database 44x. When the request 743 is not authenticated (authentication disable), the access agreement portion 31 does not update the data. Furthermore, the access agreement portion 31 returns an ad hoc network-connecting user authentication result 744 addressed to the client 10_2 which is a source of the user authentication request 743 to the ad hoc network structuring portion 14 of the client 10_1.

When the received user authentication result 744 indicates authentication enable, the ad hoc network structuring portion 14 in the client 10_1 returns an ad hoc network connection request enable/disable 731_2 indicating the authentication enable to the client 10_2, and structures the ad hoc network 62 with the client 10_2. When it indicates authentication disable, the ad hoc network structuring portion 14 returns the ad hoc network connection request enable/disable 731_2 indicating the authentication disable to the client 10_2, and does not structure the ad hoc network with the client 10_2.

As mentioned above, the client 10_1 inquires the authentication of the other client 10_2 (user 2) of the server 30, and structures the ad hoc network with the client 10_2 when it is authenticated. The server 30 registers/updates the user 2 (client 10_2) with which the client 10_1 (user 1) structures the ad hoc network in the active user database 44x.

It is to be noted that when the ad hoc network between the clients 10_1 and 10_2 is disconnected, the user 2 is deleted from the active user database 44x.

Steps S135 and S234-S235: The user 1 of the client 10_1 desires to browse e.g. the document file 0, and transmits an access request 745 including the user ID=“user 1” and the file name desired to be received=“document file 0” to the server 30. The access agreement portion 31 in the server 30 acquires a group ID/user ID 43xb=“group A” associated with the document file 0 by referring to the document file-access right management database 43x, and further acquires a user ID 42xb=“users 1-3” that is the “group A” developed by referring to the database 42x.

Also, the access agreement portion 31 acquires the ad hoc network-connecting user ID list 44xb=“user 2” corresponding to the user 1 who requests browsing from the active user database 44x, that is acquires the user 2 which forms a mutual connection between the user 1 and the ad hoc network. Since the user 2 belongs to the group A having an access right to the document file 0, the access agreement portion 31 agrees to the access (746a) to the document file 0 by the user 1 and returns an agreement determination result 746 indicating the agreement 746a to the client 10_1. When the mutual connection is not formed, the access agreement portion 31 returns the agreement determination result 746 indicating a unagreement 746b to the client 10_1.

A more detailed method of determining whether or not the mutual connection of the ad hoc network 62 is formed when the client 10_1 (=user 1) requests to browse the document file 0 will now be described based on the data contents of FIGS. 8A and 8B and FIG. 9.
(1) By referring to the document file-access right management database 43x, it is confirmed whether or not a user ID which has requested browsing is included in the user ID associated with the document file 0. If no user ID is included, it is determined that there is no mutual connection of the ad hoc network. In this example, the group A=user 1 is included.
(2) The user ID associated with the document file 0 is extracted. In this example, the users 1-3 are extracted.
(3) By referring to the active user database 44x, the user ID is extracted from the ad hoc network-connecting user ID list 44xb of the user 1 which has requested browsing. In this example, the user 2 is extracted.
(4) Operations of the user ID's extracted in the above-mentioned (2) and (3) are performed. In this example, the result of the operation is the user 2.
(5) It is determined whether or not the user ID=“user 1” which has requested browsing is included in the ad hoc network-connecting user ID list 44xb of the respective user ID of the above-mentioned (4). In this example, since the user 1 is included in the ad hoc network-connecting user ID list 44xb of the user 2, it is determined that a user ID which has requested browsing “exists”.
(6) In the above-mentioned (5), if at least a single user ID “exists”, it is determined that the mutual connection of the ad hoc networks exists. When no user ID “exists”, it is determined that no mutual connection of the ad hoc networks exists. In this example, the mutual connection of the ad hoc networks exists.

In the above-mentioned (5), if at least a single user ID “exists”, it is determined that “the mutual connection of the ad hoc networks exists”. However, if the “required number of connections” is further added in e.g. the document file-access right management database 43x of FIG. 8B as the attribute of the document file, and if it is determined that “mutual connection exists” when there are more mutual connections of the ad hoc networks in a number equal to or more than the “required number of connections”, the agreement of more users can be realized.

Steps S136, S137, S235, and S236: In the client 10_1, the access request portion 11 returns to step S135 when the agreement determination result 746 indicates “unagreement”, and provides reception preparing instructions 749 of the data (document file 0) to the data receiver 12 when the agreement determination result 746 indicates “agreement”. In the server 30, on the other hand, when there is a mutual connection of the ad hoc networks, the access agreement portion 31 provides transmission instructions 750 of the document file 0 to the data transmitter 32. When there is no mutual connection of the ad hoc networks, it does not provide the transmission instructions of the document file 0 to the data transmitter 32.

The data transmitter 32 having received the transmission instructions 750 transmits the document file 0 (data file 747) stored in the data storing portion 45 to the client 10_1. In the client 10_1 which has requested browsing, the data receiver 12 receives the document file 0 (data file 747).

Thus, it becomes possible for the user 1 to browse the document file 0 on the client 10_1.

Steps S138 and S237: After the data transfer is finished, a negotiation 748 of a disconnection is performed between the server 30 and the client 10_1, so that the connection 60a is disconnected.

Furthermore, when the structuring of the ad hoc network 62 becomes unnecessary, the ad hoc network structuring portion 14 transmits an ad hoc network disconnection request to the other client 10_2. The ad hoc network structuring portion 14 having received the ad hoc network disconnection request transmits an ad hoc network disconnecting-user authentication request including a user ID and a password of a disconnection request source to the server 30 (not shown).

When the authentication is OK, the access agreement portion 31 of the server 30 having received the ad hoc network disconnecting-user authentication request updates the active user database 44x, and transmits the ad hoc network-connecting user authentication result indicating that the authentication is OK, to the client 10_2. When the authentication is NG, the access agreement portion 31 transmits the result indicating that authentication is NG to the client 10_2 without updating the active user database 44x (not shown).

When the authentication is OK, the ad hoc network structuring portion 14 of the client 10_2 having received the above-mentioned ad hoc network-connecting user authentication result disconnects the connection of the ad hoc network 62 with the concerned other client 10_1. When the authentication is NG, the ad hoc network structuring portion 14 does not disconnect the connection of the ad hoc network 62.

Also, when the ad hoc network structuring portion 14 could not find the other client by a prior art ad hoc network technology, the portion 14 transmits the ad hoc network disconnection request of the other client to the server 30. At this time, the ad hoc network structuring portion 14 of the client 10 can not transmit authentication information (password etc.) of the other client. However, since a communication disabled state has already occurred, e.g. the distance between the mutual clients is too far, the access agreement portion 31 of the server 30 updates the active user database 44x without the authentication of the above-mentioned other client 10.

As described above, according to the access right management system 100x of the embodiment (2), a plurality of users are adjoined and positioned within an area where the ad hoc network can be structured to arrange the ad hoc network, which is thereby regarded as the agreement of the users possessing the access rights and enables the access to the data. Thus, in addition to the enhancement of the protection ability for leakage in the same way as the embodiment (1), there is an effect of realizing the agreement of the users having access rights even if each user can not acquire the absolute position.

### Embodiment (3): Distributed Hold of Data by Client

Different from the above-mentioned embodiment (2) in which the data are only held in the data storing portion 45 of the server 30, in the embodiment (3), a plurality of clients 10 distribute encoded data and keys for encoding/decoding the data to be held.

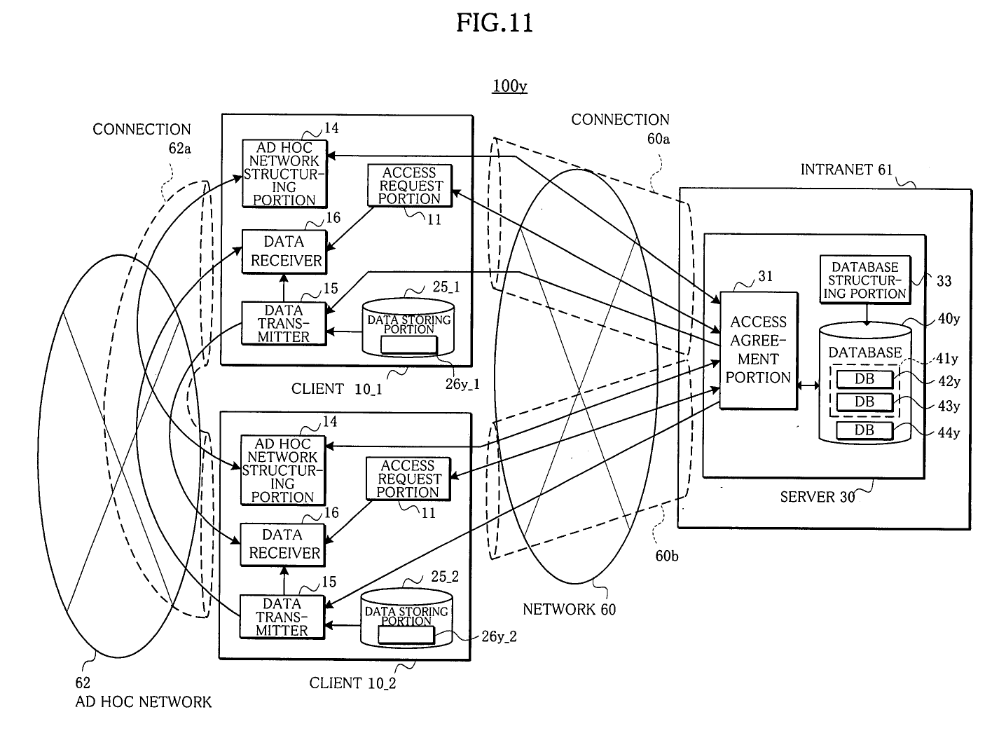

FIG. 11 shows an arrangement of an access right management system 100y in the embodiment (3) of the present invention. This access right management system 100y is different from the access right management system 100x of the embodiment (2) shown in FIG. 6 in that the data storing portion 45 included in the server 30 in the embodiment (2) is distributed to the clients 10_1 and 10_2 respectively as data storing portions 25_1 and 25_2 (hereinafter, occasionally represented by a reference numeral 25) in the embodiment (3). Furthermore, the access right management system 100y is different from the access right management system 100x of the embodiment (2) in that a data transmitter 15 and a data receiver 16 for transmitting/receiving data stored in the distributed data storing portion 25 between the clients 10 are added to the clients 10, instead of the data transmitter 32 of the server 30 for transmitting the data from the server 30 to the clients 10 and the data receiver 12 of the client 10.

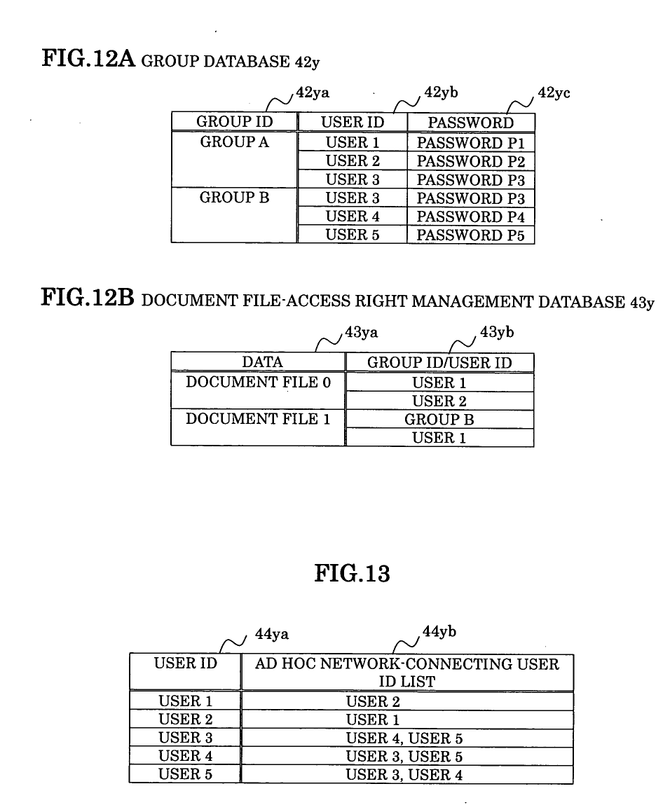

FIGS. 12A and 12B show a user account database 41y included in the server 30. FIGS. 12A and 12B respectively show a group database 42y and a document file-access right management database 43y within the user account database 41y.

The group database 42y and the document file-access right management database 43y are the same as the group database 42x and the document file-access right management database 43x shown in the embodiment (2) of FIGS. 8A and 8B.

FIG. 13 shows an active user database 44y, which is the same as the active user database 44x shown in the embodiment (2) of FIG. 9.

It is to be noted that FIGS. 12A, 12B, and FIG. 13 include data of the users 3, 4 and 5 (clients 10_3, 10_4, and 10_5) not shown in FIG. 11.

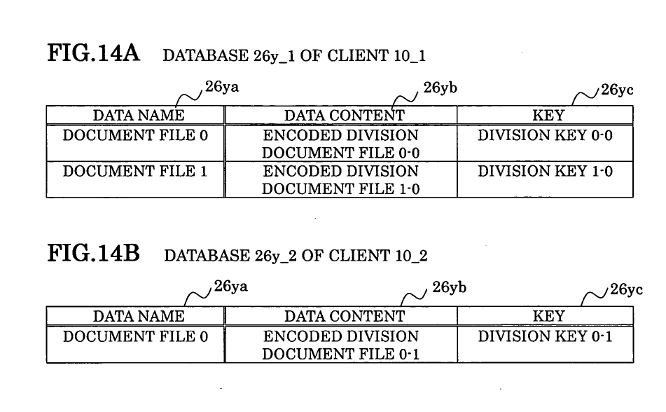

FIGS. 14A and 14B respectively show document file databases 26y_1 and 26y_2 (hereinafter, occasionally represented by a reference numeral 26y) held by the data storing portions 25 of the clients 10_1 and 10_2. The database 26y is composed of a data name 26ya, a data content 26yb, and a key 26yc. Namely, the database 26y holds the data content 26yb=“encoded division document file n-m” and a division key 26yc=“division key n-m” with the data name 26ya=document file “n” as a main key. The encoded division document file n-m means a divided portion “m” obtained by encoding the document file “n” and dividing the same. The division key n-m means a divided portion “m” obtained by dividing the key “n” of the document file “n”.

For example, the document file 0 is divided to be respectively stored in the data content 26yb of the databases 26y_1 and 26y_2 as encoded division document files 0-0 and 0-1. Also, division keys 0-0 and 0-1 that are portions of a key 0 are respectively stored in the key 26yc of the databases 26y_1 and 26y_2 in order to encode/decode (encrypt/decrypt) the encoded division document files 0-0 and 0-1.

The encoded division document files 0-0 and 0-1 are combined to form an encoded document file 0. The division keys 0-0 and 0-1 are combined to form a key 0. By decoding the encoded document file 0 with the key 0, the document file 0 which can be browsed can be obtained.

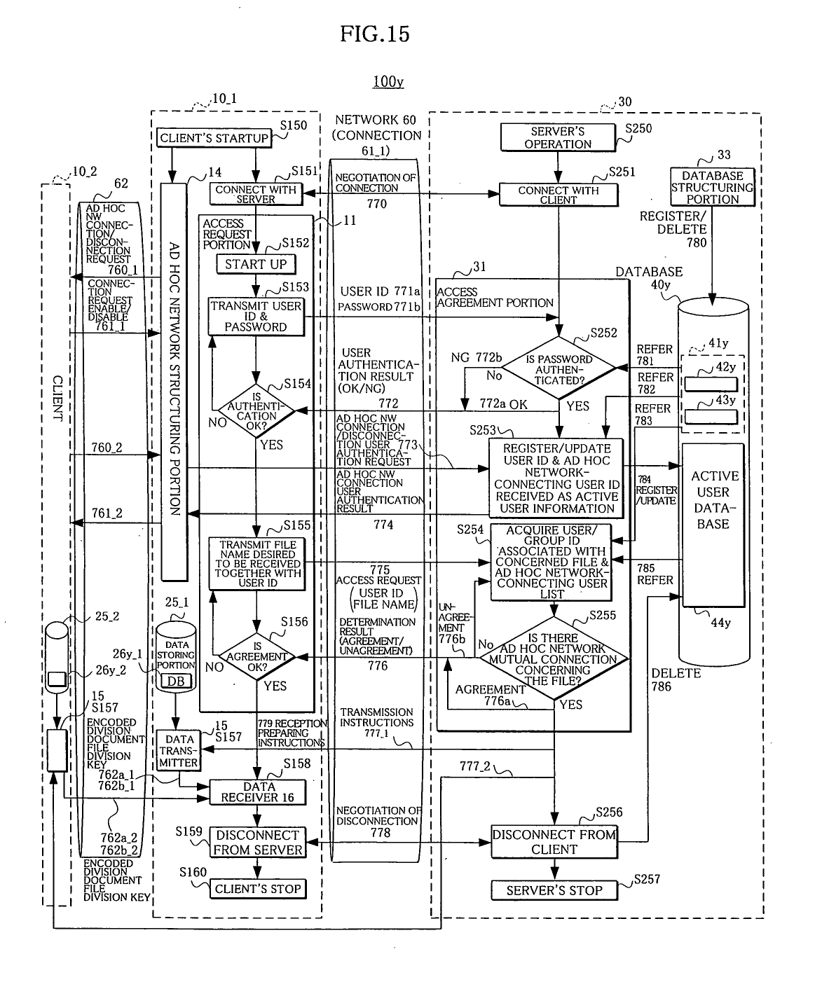

FIG. 15 shows an operation example of the access right management system 100y in the embodiment (3), which will now be described.

Steps S150-S154 and S250-S252: These steps are the same as steps S130-S134 and S230-S232 of the embodiment (2). A connection negotiation 770 and a user authentication are performed between the server 30 and the client 10_1.

Steps S155 and S253-S255: These steps are the same as steps S135, S136, and S234-S236 of the embodiment (2). The ad hoc network-connecting user ID is registered in the active user database 44y, and an access (browsing) request 775 including a user ID and a file name, and a determination result 776 indicating agreement/unagreement are transmitted/received between the client 10_1 and server 30.

It is to be noted that a determination procedure at step S255, namely a determination procedure whether or not a mutual connection of the ad hoc network is formed is different from the determination operation at step S235 of the embodiment (2).

The determination procedure in the embodiment (3) at the time when the data contents of the databases 41y (42y, 43y,), 44y, and 25y are respectively the same as those in FIGS. 12A and 12b, FIG. 13, and FIGS. 14A and 14B, and when the client 10_1 (=user 1) has performed the access (browsing) request 775 of the file name=document file 0 will now be described.
(1) In the document file-access right management database 43y, it is confirmed whether or not the user ID=“user 1” having received an access request exists in the group ID/user ID 43yb corresponding to the data 43ya=“document file 0 having received the access request”. In this example, the user 1 exists. If the user 1 did not exist, it would be determined that the user 1 has no access right to the document file 0.
(2) The user ID's except the user ID=“user 1” having received the access request are extracted from the group ID/user ID 43yb corresponding to the data 43ya=“document file 0” of the database 43y. In this example, the user 2 is extracted.
(3) In the active user database 44y, it is confirmed whether or not all of the users extracted in the above-mentioned (2) are included in the user ID registered in the ad hoc network-connecting user ID list 44yb corresponding to the user ID 44ya=“user 1 having requested access”. In this example, the user 2 is included. If it were not included, it would be determined that no mutual connection of the ad hoc network exists.
(4) With regard to all of the user ID's of the above-mentioned (2), it is determined whether or not the user ID=“user 1” having requested the access exists in the ad hoc network-connecting user ID list 44yb. In this example, since the user 1 is in the ad hoc network-connecting user ID list 44yb of the user 2, it is determined that the user ID “exists”.
(5) When the user ID “exists” in the above-mentioned (4), it is determined that the mutual connection of the ad hoc network exists. In this example, the mutual connection of the ad hoc network exists.

The determination at step S255 shown in the procedure of the above-mentioned (1)-(5) is different from that at step S235 of the embodiment (2) in that when a certain user requests access to a certain document file, and only when all of the users having access rights to the document file which is subject to the access request have structured the ad hoc network, it is determined that the “mutual connection of the ad hoc network exists”.

The reason of such a determination is that all of the users (clients) having access rights to the document file distribute and hold the document file in the embodiment (3).

It is to be noted that when the number of users having access rights to e.g. the document file 0 is large so that operational conveniences are reduced, it may be determined that the ad hoc network mutual connection exists when not all of the users but specific two or more users combined structure the ad hoc network with each other. In this case, the document file database 26y (see FIGS. 14A and 14B) of each client 10 may hold the encoded division document file and the division key per user combination pattern for each document file.

Step S156: In the client 10_1, the access request portion 11 provides reception preparing instructions 779 to the data receiver 12 when receiving the determination result 776 indicating “agreement”.

Steps S157 and S255: When the determination result 776 is “agreement (ad hoc network mutual connection exists)” in the access agreement portion 31, the server 30 provides transmission instructions 777_1 and 777_2 (hereinafter, occasionally represented by a reference numeral 777) of the document file 0 respectively to the clients 10_1 and 10_2. The transmission instructions 777 include the user ID=“user 1” of the client 10_1 which is the browsing request source, and the file name=“document file 0”.

The data transmitter 15 of each client 10 having received the transmission instructions 777 reads the encoded division document file and the division key corresponding to the document file 0 from the document file databases 26y_1 and 26y_2 of the data storing portions 25_1 and 25_2. When the client itself is an access request source, the data transmitter 15 transmits an encoded division document file 762a_1 and a division key 762b_1 to its own data receiver 12. When the client itself is not the access request source, the data transmitter 15 transmits an encoded division document file 762a_2 and a division key 762b_2 to the data receiver 12 of the client 10_1 which is the access request source instructed by the transmission instructions 777.

Step S158: In the client 10_1, the data receiver 16 receives all of the encoded division document files and all of the division keys of the document file 0. The data receiver 16 combines the encoded division document files and the division keys respectively, forms the encoded document file 0 and the key 0, decodes the encoded document file 0 with the key 0, and prepares the document file 0 which can be browsed. Thus, it becomes possible for the user 1 of the client 10_1 to browse the document file 0.

Steps S159, S160, S255, and S256: The procedure of a negotiation 778 of disconnecting the connection 60a between the client 10_1 and the server 30 is the same as that of the negotiation 748 of disconnection shown at steps S138, S139, S237, and S238 of the embodiment (2).

Thus, the client 10 distributes and holds the data (document file), thereby enabling the protection ability for the leakage to be enhanced in the same way as the embodiment (1). Also, it becomes possible to save a used bandwidth of the network 60 between the server 30 and the clients 10. Namely, it becomes possible to transmit/receive larger-capacity document file data mutually between the clients 10 without using the network 60, between the clients 10 and the server 30, whose bandwidth is narrower than the ad hoc network 62 and which is charged on an as-used basis. As a result, there is an effect of saving the used bandwidth of the network 60 between the server 30 and the clients 10.

Furthermore, even if the security of each client 10 is broken, complete data (document file) are not leaked, thereby enabling a protection ability for the leakage to be enhanced.

It is to be noted that while the document file and the key are distributed and held in the above-mentioned embodiment (3), it is possible to distribute only the key to be held. When only the key is distributed and held, and when the security of a certain client is broken, there is a risk of leaking a complete file. However, the used bandwidth of the ad hoc network 62 can be saved.

### Embodiment (4): Distributed Hold of Access Agreement Portion by each Client

In this embodiment (4), the function of the access agreement portion 31 of the server 30 in the embodiment (3) is distributed to each client 10 as an access agreement portion 18. As a result, the server 30 is not required in this embodiment (4).

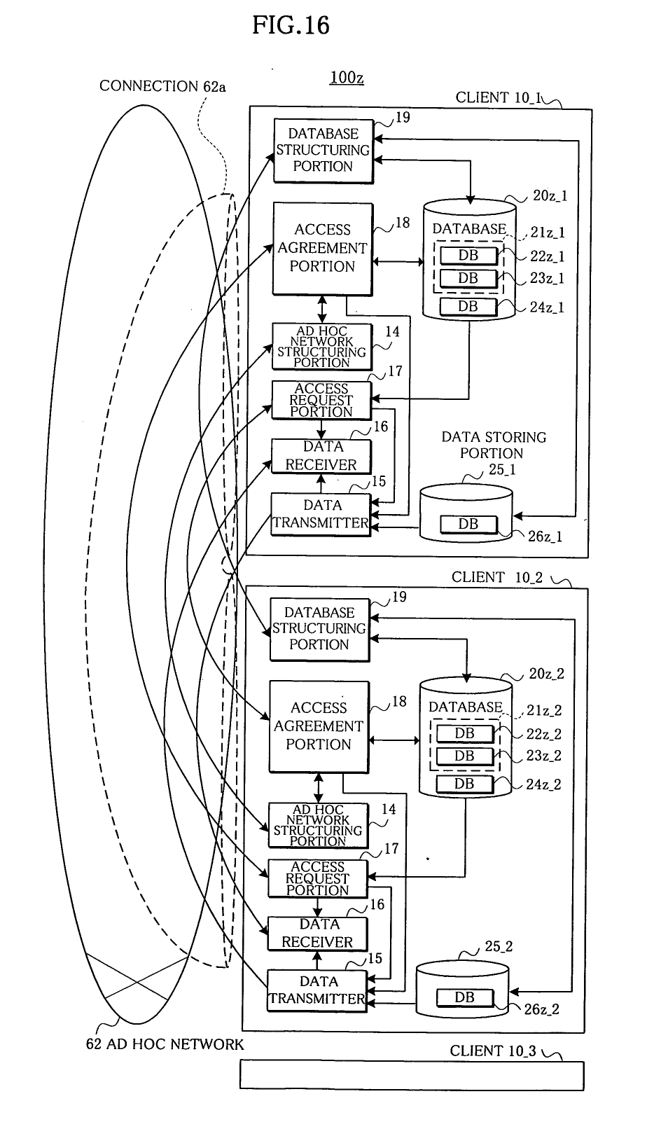

FIG. 16 shows an arrangement of an access right management system 100z in the embodiment (4) of the present invention. This access right management system 100z is composed of e.g. a plurality of clients 10_1-10_3. The arrangement of each client 10 is different from that of the client 10 shown in the embodiment (3) in that an access request portion 17 requesting the access mutually between the clients 10 is substituted for the access request portion 11 requesting the access to the server 30. Also, different from the embodiment (3), each client 10 in the embodiment (4) is provided with the access agreement portion 18, a database structuring portion 19, and a database 20z (generic name for reference numerals 20z_1 and 20z_2) as substitutes for the access agreement portion 31, the database structuring portion 33, and the database 40y held by the server 30 in the embodiment (3).

The embodiment according to [1] “agreement of access right to document” and the embodiment according to [2] “access right management upon distributing database structuring portion” in the embodiment (4) will now be separately described.

[1] Agreement to Access Right to Document

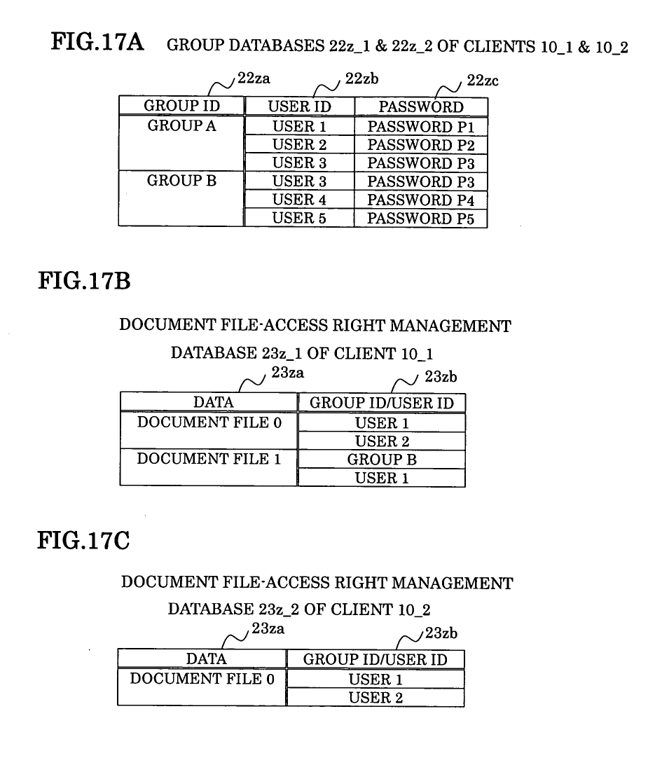

FIGS. 17A-17C show a user account database 21z composing the database 20z. This database 21z is composed of a group database 22z and a document file-access right management database 23z.

FIG. 17A shows group databases 22z_1 and 22z_2 held by the clients 10_1 and 10_2. The group databases 22z_1 and 22z_2 are the same databases, and are composed of a group ID 22za, a user ID 22zb, and a password 22zc.

FIGS. 17B and 17C respectively show document file-access right management databases 23z_1 and 23z_2 (hereinafter, occasionally represented by a reference numeral 23z) of the clients 10_1 and 10_2, and are composed of data 23za and a group ID/user ID 23zb. The database 23z is a database concerning a document file to which each client 10 itself has an access right. For example, in the database 23z_1 of FIG. 17B, the client 10_1 holds the user ID's including its own user ID having the access right to the document files 0 and 1, while in the database 23z_2 of FIG. 17C, the client 10_2 holds the user ID's having the access right to the document file 0.

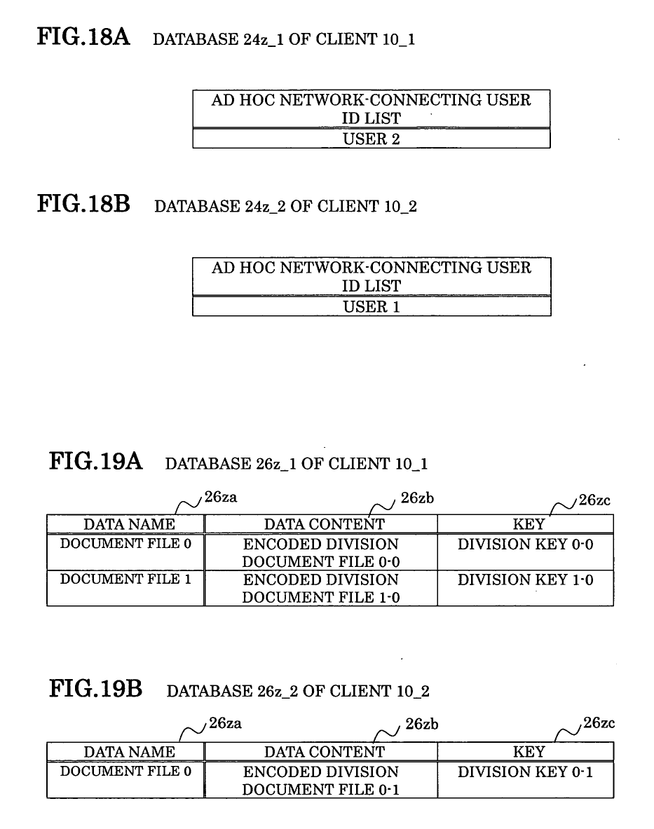

FIGS. 18A and 18B respectively show active user databases 24z_1 and 24z_2 held by the clients 10_1 and 10_2. The databases 24z_1 and 24z_2 respectively hold the ad hoc network-connecting user ID list by which the clients 10_1 and 10_2 compose the ad hoc network.

FIGS. 19A and 19B respectively show document file databases 26z_1 and 26z_2 (hereinafter, represented by a reference numeral 26z) held by the clients 10_1 and 10_2. The document file database 26z is the same as the document file database 26y of the embodiment (3) shown in FIGS. 14A and 14B, and is composed of a data name 26za, a data content 26zb, and a key 26zc.

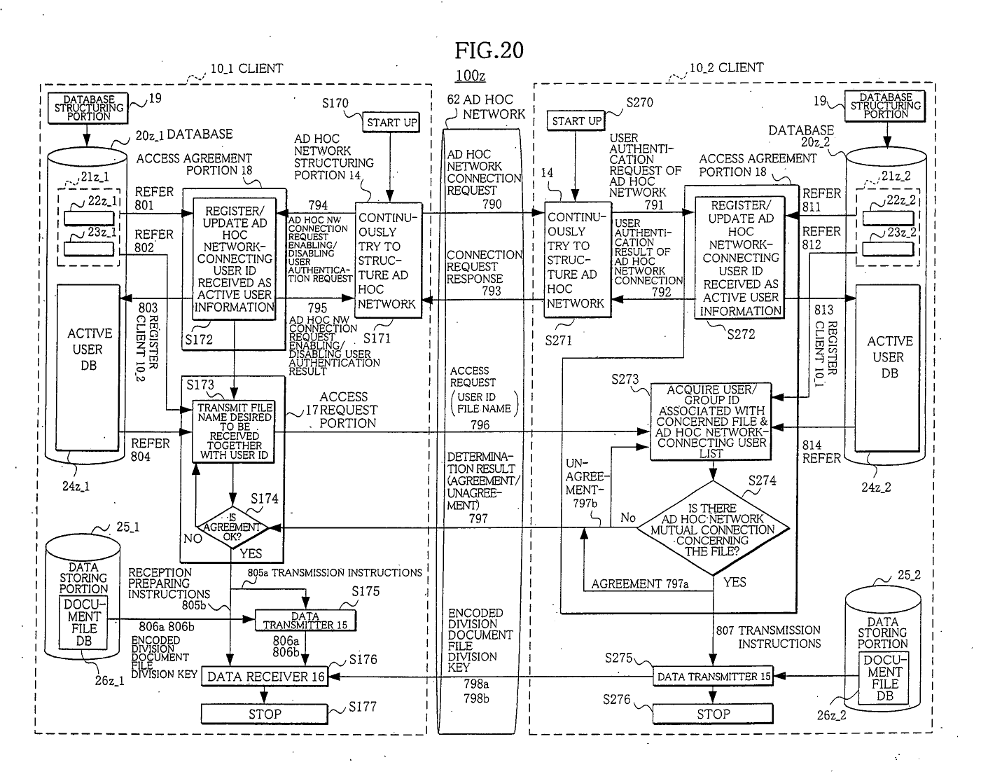

FIG. 20 shows an operation procedure in the embodiment (4). This operation procedure will now be described. It is to be noted that while the operation procedure of the case where only two clients 10_1 and 10_2 exist will now be described, the operation procedure of the case where three or more clients exist is the same.

Steps S170 and S270: The clients 10_1 and 10_2 respectively start up.

Steps S171, S172, S271, and S272: The ad hoc network structuring portions 14 of the clients 10_1 and 10_2 respectively and continuously structure the ad hoc network 62 with the other client. Namely, in the client 10_1, the ad hoc network structuring portion 14 transmits an ad hoc network connection request 790 to the client 10_2. In the client 10_2, the ad hoc network structuring portion 14 having received the ad hoc network connection request 790 provides a user authentication request 791 of the ad hoc network connection to the access agreement portion 18. The access agreement portion 18 performs an authentication in the same way as the embodiment (3) by referring (811) to the user account database 21z_2, and returns a user authentication result 792 of the ad hoc network connection to the ad hoc network structuring portion 14. Furthermore, when the authentication is OK, the access agreement portion 18 registers (813) the client 10_1 (=user 1) in the active user database 24z_2.

The ad hoc network structuring portion 14 having received the user authentication result 792 transmits an ad hoc network-connecting request response 793 to the ad hoc network structuring portion 14 of the client 10_1. This response 793 includes authentication information (user 2 and password P2) of the client 10_2.

In the client 10_1, the ad hoc network structuring portion 14 having received the response 793 transmits a user authentication request 794 including the authentication information (user 2 and password P2) included in the response 793 to the access agreement portion 18. This access agreement portion 18 performs an authentication by referring (801) to the user account database 21z_1, and provides a user authentication result 795 to the ad hoc network structuring portion 14. Furthermore, when the authentication is OK, the access agreement portion 18 registers (803) the client 10_2 (=user 2) in the active user database 24z_1.

By performing this sequential operation for the ad hoc network structuring, the users 2 and 1 are registered/updated in the active user databases 24z_1 and 24z_2 of FIGS. 18A and 18B.

Steps S173, S273, and S274: In the client 10_1, the access request portion 17 extracts all of the user ID's except its own user ID having access rights to the document file 0 by referring (802) to the document file-access right management database 23z_1 of the user account database 21z_1. In this example, the user 2 is extracted. Furthermore, the access request portion 17 confirms that the extracted user ID=user 2 is in the ad hoc network-connecting user ID list (active user database 24z_1 (see FIG. 18A)) by referring (804) to the active user database 24z_1. In this example, the user 2 is in the ad hoc network-connecting user ID list. The access request portion 17 transmits an access (browsing) request 796 to all of the clients except its own client having the access rights to the document file 0. Namely, the access request portion 17 transmits the access request 796 of the document file 0 to the client 10_2.

In the client 10_2, the access agreement portion 18 having received the access request 796 determines, by referring (814) to the active user database 24z_2, whether or not the ad hoc network mutual connection is formed with the client 10_1 (user 1). When it is formed, the access agreement portion 18 returns a determination result 797 indicating “agreement 797a” to the client 10_1 which has transmitted the access request 796, and provides data transmission instructions 807 to the data transmitter 15. When it is not formed, the determination result 797 indicating “unagreement 797b” is returned.

More detailed determination operation of “whether or not mutual connection of the ad hoc network 62 is formed” at step S274 will now be described.
(1) By referring to the document file-access right management database 23z_2, whether or not the user ID=user 1 having requested the access is included in the user ID's associated with the document file 0 is confirmed. If the user 1 is not included, it is determined that no access right exists. In this example, since the user 1 exists, it is determined that an access right exists.
(2) By referring to the active user database 24z_2, it is confirmed whether or not the user ID=user 1 having requested the access is included in the ad hoc connection user ID list. If the user 1 is not included, it is determined that no mutual connection of the ad hoc network exists. In this example, since the user 1 exists, it is determined that a mutual connection “exists”.
(3) In the above-mentioned (2), when it is determined that a mutual connection “exists”, it is determined that a mutual connection of the ad hoc network exists. In this example, a mutual connection of the ad hoc network exists.
Step S174: When receiving the agreement determination result 797 indicating “agreement” from all of the clients (in this example only client 10_2) to which the access request 796 has been transmitted, the access request portion 17 in the client 10_1 provides data transmission instructions 805a instructing the transmission of the encoded division document file 0-0 and the division key 0-0 to the data transmitter 15, and reception preparing instructions 805b to the data receiver 16.

Steps S175, S176, and S275: In the client 10_2, the agreement portion 18 provides transmission instructions 807 of the encoded division document file 0-1 and the division key 0-1 held in the document file database 26z_2 to the data transmitter 15. The data transmitter 15 transmits an encoded division document file 798a and a division key 798b including the document file 0-1 and the division key 0-1 respectively to the client 10_1.

In the client 10_1, the encoded division document file 0-1 and the division key 0-1 are received from the data transmitter 15. The data transmitter 15 of the client 10_1 provides the encoded division document file 0-0 and the division key 0-0 held by the document file database 26z-1 respectively included in an encoded division document file 806a and a division key 806b to the data receiver 16. The data receiver 16 combines the received encoded division document files 0-0 and 0-1 and the division keys 0-0 and 0-1, forms the encoded document file 0 and the key 0, decodes the encoded document file 0 with the key 0, and prepares the document file 0.

As a result, it becomes possible for the user 1 of the client 10_1 to browse the document file 0.

Steps S177 and S276: The clients 10_1 and 10_2 respectively stop.

According to the above-mentioned operation procedure, a plurality of clients 10 can distribute and hold the access agreement portion. As a result, it becomes possible to enjoy the same effect as the embodiment (3) and to access the document file in the situation without the server 30.

[2] Access Right Distribution Management

The operation procedure upon distributing an access right will now be described. In this description, the case where the clients 10_1 and 10_2 distribute and hold e.g. the document file 0 will now be described.

Firstly, the client 10_1 (=user 1), the client 10_2 (=user 2), and a client 10_3 (=user 3) structure the ad hoc network 62. When the client 10_3 requests an access right to the document file 0 to which the client 10_3 has no access right, access management functions of database structuring portions 19_1-19_3 in the clients 10_1-10_3 distribute the document file 0 to the clients 10_1-10_3.

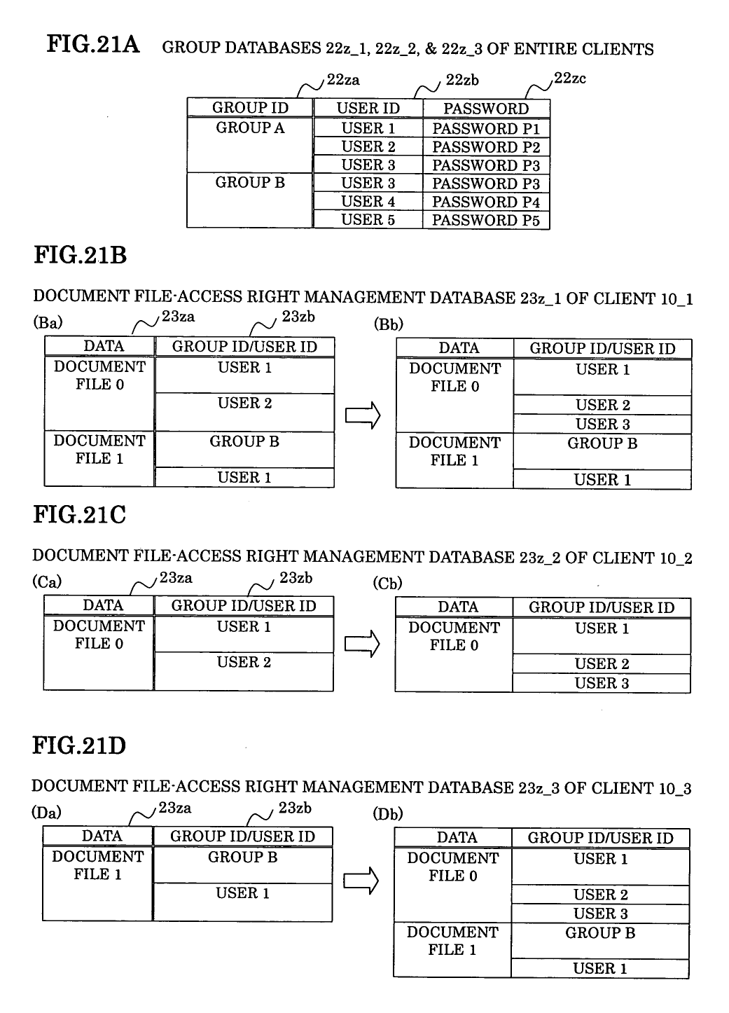

FIGS. 21A-21D show a user account database 21z in the access right distribution management of the embodiment (4). This database 21z is composed of a group database 22z shown in FIG. 21A and a document file-access right management database 23z different per client shown in FIGS. 21B-21D.

The group database 22z of FIG. 21A is common to all of the clients 10_1-10_3, and is the same as the group database 22z of the embodiment (4). The document file-access right management databases 23z_1-23z_3 (hereinafter, occasionally represented by a reference numeral 23z) of FIGS. 21B-21D are respectively held by the clients 10_1-10_3, and are the same as the database 23z of the embodiment (3) shown in FIGS. 17B and 17C. The database 23z_3 of the client 10_3 in FIG. 21D shows that the client 10_3 manages a document file 1 at present.

It is to be noted that (Ba), (Ca), (Da) of the database 23z in FIGS. 21B-21D show the databases 23z_1-23z_3 before update, and (Bb), (Cb), (Db) show the databases 23z_1-23z_3 after update.

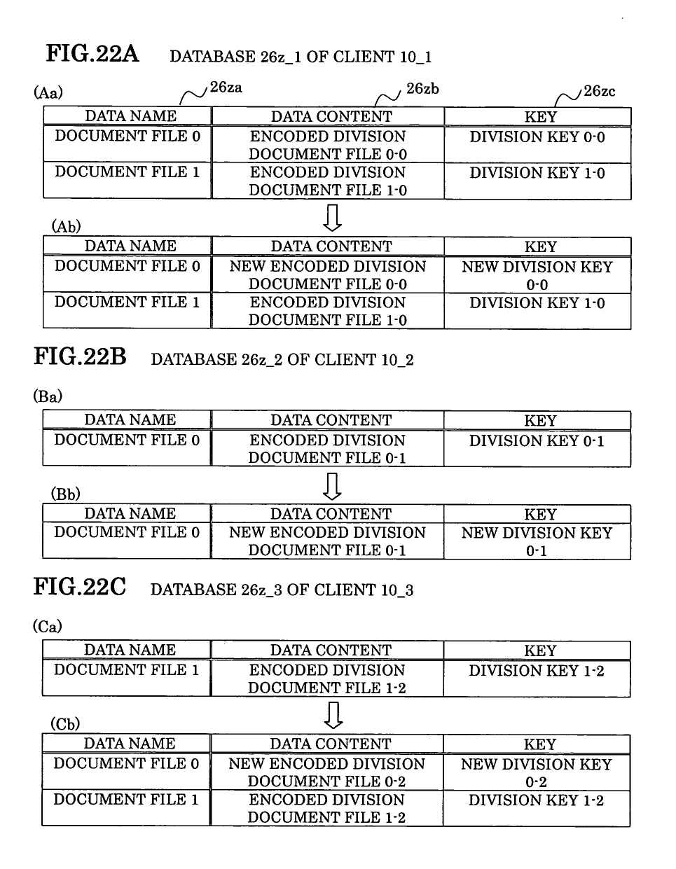

FIGS. 22A-22C show document file databases 26z_1-26z_3 (hereinafter, occasionally represented by a reference numeral 26z) respectively held by the clients 10_1-10_3. The databases 26z_1 and 26z_2 are the same as the document file databases 26z_1 and 26z_2 shown in FIGS. 19A and 19B. The database 26z_3 of the client 10_3 shows that the client 10_3 manages an encoded division document file 1-2 within the document file 1 and a division key 1-2 of the key 0.

It is to be noted that (Aa), (Ba), (Ca) in FIGS. 22A-21C show the databases 26z_1-26z_3 before updated, and (Ab), (Bb), (Cb) show the databases 26z_1-26z_3 after updated.

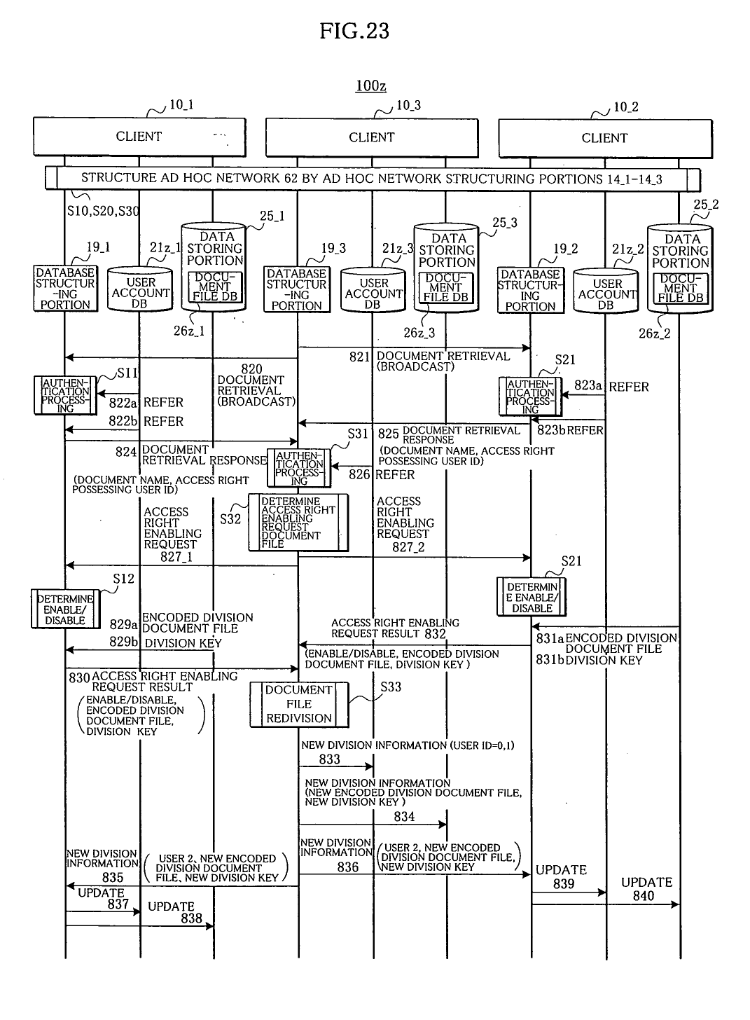

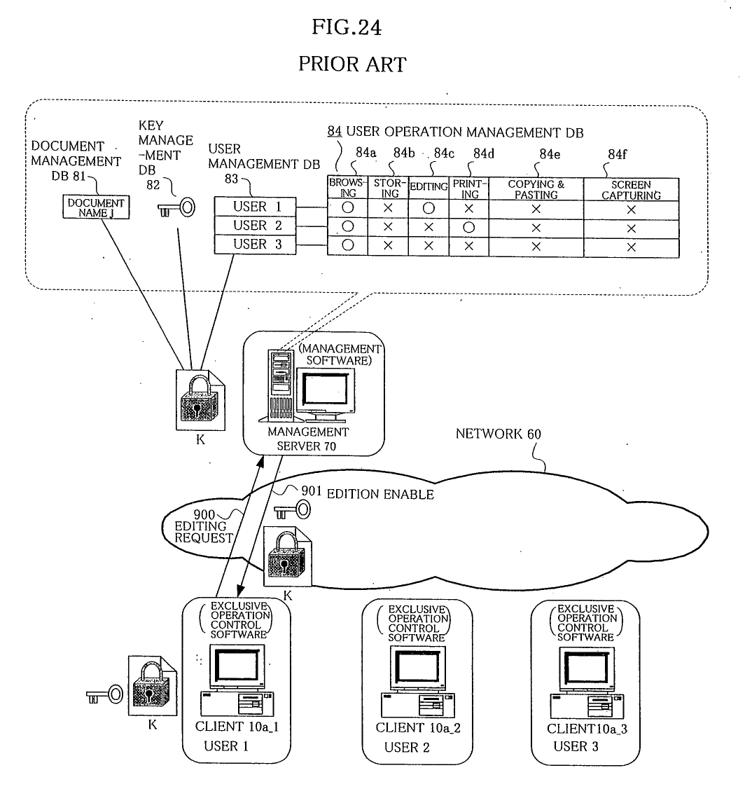

FIG. 23 shows an operation procedure in the access right distribution management of the embodiment (4). This operation procedure will now be described. It is to be noted that ad hoc network structuring portions 14_1-14_3 of the clients are provided with the access right distribution management functions.

Steps S10, S20, and S30: In the clients 10_1-10_3, the ad hoc network structuring portions 14_1-14_3 structure the ad hoc network 62. The database structuring portion 19_1 of the client 10_3 broadcasts document retrievals 820 and 821 to all of the clients 10_1 and 10_2 except itself composing the ad hoc network 62. Namely, since the client 10_3 does not recognize the existence itself of the document file to which an access right is requested, it is required to retrieve the document file existing. It is to be noted that a retrieval keyword may be included in a retrieval condition.

Steps S11 and S21: In the client 10_1, the database structuring portion 19 having received the document retrieval 820 authenticates a document retrieval message by referring (822a) to the user account database 21z_1. When the authentication is OK, the database structuring portion 19_1 returns to the client 10_3 all of the document names (or document names coincident with the retrieval condition when there is a retrieval condition) and the user ID's possessing the access rights to the documents by referring (822b) to the user account database 21z_1. Similarly, the client 10_2 returns to the client 10_3 the document names and the user ID's possessing the access rights.

Step S31: In the client 10_3, the database structuring portion 19_3 authenticates the message of the retrieval result returned from the clients 10_1 and 10_2 by referring (826) to the user account database 21z_3, and extracts the messages whose authentication is OK. In this example, the authentication of all of the messages is supposed to be OK.

Step S32 (determination of access right enabling request document file): Furthermore, the database structuring portion 19_3 determines a document file to which the access right is requested. It is supposed that this determination is manually performed e.g. by the user 3. In this example, the document file 0 is determined. The database structuring portion 19_3 transmits access right enabling requests 827_1 and 827_2 respectively to all of the clients 10_1 (=user 1) and 10_2 (=user 2) having the access rights to the document file 0.

Steps S12 and S21: In the client 10_1, the database structuring portion 19_1 having received the access right enabling request 827_1 determines an access right enable/disable, and transmits an access right enabling request result 830 to the client 10_3. When the access right enable/disable is “enable”, the database structuring portion 19_1 reads an encoded division document file 829a and a division key 829b respectively including the encoded division document file 0-0 and the division key 0-0 from the document file database 26z_1 and includes the encoded division document file 829a and the division key 829b in the access right enabling request result 830. The above-mentioned enable/disable determination may be manually performed by e.g. the user 1, or automatically by an agent to which an “enable” condition is preliminarily provided, instead of the user's manual determination.

In the client 10_2, the database structuring portion 19_2 returns an access right enabling request result (enable; encoded division document file 0-1 and division key 0-1) 832 to the client 10_3 by the same operation procedure.

Step S33: In the client 10_3, the database structuring portion 19_3 receives all of the encoded division document files of the document file 0 and all of the division keys of the key 0, and performs redivision processing of the document file 0. It is to be noted that when the access right enable result received is not enable, the database structuring portion 19_3 does not perform the subsequent processing, and the client 10_3 can not obtain the access right.

The redivision processing of the document file is of once combining the encoded division document files, decoding the combined document file to obtain the complete document file 0, and then redividing the complete document file 0 again into three users 1-3 (clients 10_1-10_3) including the user 3 (client 10_1) who has newly become an access right possessing user. The database structuring portion 19_3 of the client 10_3 updates the user account database 21z_3 and the document file database 26z_3 respectively based on new division information 833 and 834. Furthermore, the database structuring portion 19_3 transmits new division information 835 and 836 respectively to the clients 10_1 and 10_2.

In the clients 10_1 and 10_2, the database structuring portions 19_1 and 19_2 respectively update (837-840) the user account databases 21z_1 and 21z_2, the document file databases 26z_1 and 26z_2 based on the new division information 835 and 836 received.

As a result, the user account databases 21z_1-21z_3 and the document file databases 26z_1-26z_3 are updated as shown in FIGS. 21B-21D and FIGS. 22A(Ab), 22B(Bb), 22C(Cb), based on the new division information. Namely, the update of the document file-access right management database distributed and held, and the update of the document file database corresponding to that update are realized.

As described above, according to the embodiment (4), the agreement of the access right possessing users to the document can be realized without communicating with the server 30. Also, there is an effect of realizing the access to the document by structuring the ad hoc network 62 as appropriate by the client 10 in the situation there is no communication infrastructure with the server, since no communication with the server 30 is required. Also, there is an effect that a system can be structured without a server, information leakage is prevented from a privileged server management person, and protection ability for the leakage of the system can be enhanced.

Also, when e.g. a completely new user 6 takes part in this system, a client 10_6 (=user 6) transmits its own authentication information (password in this example) to the other clients, thereby enabling the update of the group database to be realized.

It is to be noted that the database structuring portion (access right management function) is a database structuring portion for structuring the user account database including the group database which realizes a general user admission and the document file-access right management database which realizes the management of the access right possessing users per document file, and data contents of the database.

Also, for the purpose of obtaining only the effect of enhancing the protection ability for the leakage of the system by structuring the system without a server, a network between the clients need not always be an ad hoc network, but may be a general wired LAN.

1. An access right management system comprising:
a user account database associating a plurality of users, with data, who possess access rights to the data;
an active user database indicating users who agree to an access to the data at present among the access right possessing users; and
an access agreement portion which agrees, only when a present number of the access right possessing users having agreed and indicated in the active user database is plural, to the access to the data with access right possessing users who have requested the access to the data.

2. The access right management system as claimed in claim 1 wherein the system is composed of a server and one or more clients,
the server is provided with the user account database, the active user database, and the access agreement portion,
each of the clients is provided with a position information detector which detects a present position of its own, and an access request portion which transmits the detected present position and an access request received from the user to the access agreement portion, and
the access agreement portion registers the received present position associated with the access right possessing users in the active user database, and a number of users positioned within a predetermined area is made a present number of agreed users.

3. The access right management system as claimed in claim 1 wherein the system is composed of a server and one or more clients,
the server is provided with the user account database, the active user database, and the access agreement portion,
each of the clients is provided with a network structuring portion which structures a network with other clients, and an access request portion which transmits identification information of the access right possessing users of the client which has structured the network and an access request received from the user of its own client to the access agreement portion, and
the access agreement portion registers the access right possessing users of the identification information in the active user database as the access right possessing users who have agreed to the access to the data.

4. The access right management system as claimed in claim 1 wherein each of clients is further provided with a network structuring portion and an access request portion besides the user account database, the active user database, and the access agreement portion,
the network structuring portion structures a network with other clients,
the access agreement portion registers the access right possessing users of the client connected to the structured network in the active user database as the access right possessing users who have agreed to the access to the data, and
the access request portion provides an access request received from the user of its own client to the access agreement portion of the client holding the data.

5. The access right management system as claimed in claim 4 wherein each of the clients is further provided with a database structuring portion, and the database structuring portion registers a plurality of associated users who possess the access rights to the data in the user account database or deletes the users from the user account database.

6. The access right management system as claimed in claim 2 wherein the server holds the data.

7. The access right management system as claimed in claim 2 wherein the client is further provided with a data storing portion which holds the data distributed, and a data transmitter and receiver which transmit/receive the data with other clients.

8. The access right management system as claimed in claims 1, further comprising a database structuring portion which registers a plurality of associated users who possess the access rights to the data in the user account database or deletes the users from the user account database.

9. An access right management method comprising:
a first step of registering a plurality of associated users who possess access rights to data;
a second step of registering users who agree to access to the data at present among the access right possessing users; and
a third step of agreeing, only when a present number of access right possessing users having agreed is plural, to the access to the data with access right possessing users who have requested the access to the data.
